(19) United States
(12) Patent Application Publication
(10) Pub. No.: US 2026/0298729 A1
(43) Pub. Date: Oct. 1, 2026

(54) FLEXIBLE TEMPERATURE PROBE

(71) Applicant: Photon Control Inc., Richmond (CA)

(72) Inventors: Celestino Andrew Borja, Richmond (CA); Jose Jay Ruben Joven Apeles, Richmond (CA); Lewis Vernon Milino Janzen, Richmond (CA); Yi Liu, Richmond (CA); Michael Tischler, Richmond (BC); Yoshua Ichihashi, Richmond (CA); Philippe Michael Schick, Richmond (CA)

(21) Appl. No.: 19/480,542

(22) PCT Filed: May 17, 2024
(86) PCT No.: PCT/CA2024/050669

§ 371 Date: Oct. 31, 2025

Related U.S. Application Data
(60) Provisional application No. 63/503,080, filed on May 18, 2023.

(51) Int. Cl. G01K 11/3206; G01J 5/02; G01J 5/04; G01J 5/0821

(52) U.S. Cl. CPC G01K 11/3206; G01J 5/0205; G01J 5/04; G01J 5/0821

(57) ABSTRACT

Various embodiments of a flexible fiber optic temperature probe are disclosed. In one embodiment, the flexible fiber optic temperature probe includes a plurality of fiber optic elements in optical communication with a temperature sensing sub-assembly, and a flexible jacket surrounding the plurality of fiber optic elements. The flexible jacket is secured to the sensing sub-assembly to prevent relative movement between the flexible jacket and the sensing sub-assembly. The sensing sub-assembly, the flexible jacket and the plurality of fiber optic elements are sized to be inserted into a channel formed in a body (e.g., a semiconductor chamber showerhead) having one or more bends formed therein. The temperature sensing sub-assembly includes at least one sensing element such as a thermographic phosphor element placed in thermal communication with at least one surface or region to be measured.

### CROSS-REFERENCE TO RELATED APPLICATIONS

The present application claims priority to U.S. Provisional Patent Application Ser. No. 63/503,080—entitled “Flexible Temperature Probe” filed on May 18, 2023, the contents of which are incorporated by reference herein.

### TECHNICAL FIELD

The following generally relates to fiber optic temperature probes, and particularly to flexible fiber optic temperature probes that can bend around a radius to thermally communicate with a desired surface or location to be measured.

### BACKGROUND

Normally, fiber optic probes are designed to include a shaft having a connector (i.e., proximal) end and a distal end. A sensing element is configured at the distal end of the shaft, and a fiber optic rod positioned inside the shaft is in optical communication with the sensing element to determine a characteristic, (e.g. a temperature) based on light emitted, reflected, or scattered by the sensing element. Fiber optic probes are typically inserted into a body such that the distal end is positioned in the region where the characteristic is to be measured. Because of the inflexible nature of such rigid probes, they are limited to applications where the region to be sensed can be reached by insertion of the probe shaft into the body in a straight-line path. In various applications, such a straight-line path may not exist, for example, when other elements or features in the body would interfere with a straight-line path. Fiber optic probes that allow insertion into non straight-line path or channel would be desirable.

### SUMMARY

The present disclosure describes various embodiments of flexible fiber optic temperature probes.

In one embodiment, the flexible fiber optic temperature probe comprises a plurality of flexible fiber optic elements having a first end and a second end and a temperature sensing sub-assembly disposed on and in optical communication with the second end of the plurality of flexible fiber optic elements. The flexible temperature probe may further comprise a flexible jacket surrounding the plurality of fiber optic elements and secured to the temperature sensing sub-assembly, wherein the flexible jacket is operative to prevent relative movement between the flexible jacket and the temperature sensing sub-assembly. The flexible jacket may comprise at least one of metal, fiber or silica. In various embodiments, the flexible jacket comprises a metal with at least one of a squarelock, interlock, monocoil, gooseneck, bellows or drag chain construction. In one embodiment, the flexible jacket includes a bend-limiting construction. In some embodiments, the flexible jacket comprises at least one of aluminum, steel, stainless steel, titanium, nickel, gold, silver or alloys thereof. The flexible jacket may have a minimum radius of curvature of 50 mm or less or 25 mm or less. In other embodiments, the flexible fiber optic temperature probe further comprises a rigid tip wherein the rigid tip is configured to enclose all or at least a portion of the sensing sub-assembly and at least a portion of the second end of the plurality of flexible fiber optic elements. In one embodiment, the rigid tip may be formed from metal. In other embodiments, the rigid tip is configured to enclose all or at least a portion of the sensing sub-assembly and at least a portion of the second end of the plurality of flexible fiber optic elements and the rigid tip is attached to at least a portion of the flexible jacket.

In other embodiments, the rigid tip has a length C and a diameter or width t′, wherein the fiber optic temperature probe is configured to be inserted and/or removed from a channel having a width or diameter Wand an outer radius of curvature RO; and the minimum width Wmin of the channel is to allow the fiber optic temperature probe to be inserted and passed through is determined by the formula:

$${W}_{min} = R O - \sqrt{{RO}^{2} - {( C / 2 )}^{2}} + {t}^{′}$$

The flexible fiber optic temperature probe may further comprise a mount configured to engage an opening of a channel, the mount being a channel-length distance from the sensing sub-assembly, wherein the mount is secured the flexible jacket to prevent relative movement between the flexible jacket and the sensing sub-assembly.

The flexible fiber optic temperature probe may further comprise a sensing sub-assembly including a ferrule having a first end and a second end and a tip having a sensing element positioned therein, wherein the tip is secured to the second end of the ferrule. In some embodiments, the tip is detachably secured to the second end of the ferrule. In some embodiments, the flexible jacket is secured to the sensing sub-assembly by one or more of a friction fit, welding, crimping, an overmold, a dip coat, potting compound, and an adhesive connection. In other embodiments, the flexible jacket is disposed at least in part between an exterior portion and an interior portion of the sensing sub-assembly, and the flexible jacket is crimped to one or both of the exterior portion or the interior portion.

The present disclosure also describes embodiments of a body or structure comprising a body including a channel having at least one bend, the channel ending at a surface, and a temperature probe comprising a plurality of fiber optic elements, a sensing sub-assembly having a first and a second end, the first end connected to a distal portion of the plurality of fiber optic elements, and a flexible jacket surrounding the plurality of fiber optic elements and secured to the sensing sub-assembly to prevent relative movement between the flexible jacket and the sensing sub-assembly, wherein the temperature probe is positioned within the channel and passing through the at least one bend so the sensing sub-assembly is in thermal communication with the surface. The flexible jacket is formed from at least one of polytetrafluoroethylene, fiber, silica, or a metal.

In other embodiments, the flexible fiber optic temperature probe may include a bundle of fiber optic elements having a first end and a second end, a collar having a first internal passage, the collar being secured to at least one of the first end and the second end of the bundle of fiber optic elements within the first internal passage, and a sensing sub-assembly including a first part and a second part, wherein the first part includes a second internal passage for receiving the collar, wherein the first part of the sensing sub-assembly is secured to the collar within the second internal passage, a flexible jacket surrounding the bundle of fiber optic elements, a projection formed on the collar, wherein the projection is configured to be secured to a portion of the flexible jacket, and wherein the second part includes a sensing element. The first part and the second part of the sensing sub-assembly may be removably attached, and the first part of the sensing sub-assembly may be adhesively fixed to the collar.

In other embodiments, the flexible fiber optic temperature probe may include one or more flexible fiber optic elements; and a plurality of sensing points in optical communication with the one or more flexible fiber optic elements, wherein the plurality of sensing points are in optical communication with at least a portion of the one or more flexible fiber optic elements, and at least one of the plurality of sensing points is configured to sense a temperature. In one embodiment, at least one of the plurality of sensing points include at least one thermographic phosphor temperature sensing element. In other embodiments, wherein at least one of the plurality of sensing points includes at least one FBG sensor, wherein the at least one FBG sensor is configured to sense at least one of temperature or strain.

### BRIEF DESCRIPTION OF THE DRAWINGS

Embodiments will now be described with reference to the appended drawings wherein:

FIG. 1 shows a partial cross-section view of an example embodiment of a body having a channel.

FIG. 2 shows an enlarged cross-section view of the bend in the channel shown in FIG. 1.

FIGS. 3A and 3B show schematic views illustrating example embodiments of sensing sub-assemblies interacting with a channel.

FIG. 4 shows a perspective view of an example embodiment of a flexible fiber optic temperature probe.

FIGS. 5A and 5B show views of the example embodiment of the flexible fiber optic temperature probe in FIG. 4.

FIG. 6 shows an cross-section view of an example embodiment of a mount for a flexible fiber optic temperature probe.

FIGS. 7A and 7B show each cross-section views of example embodiments of a temperature sensing sub-assembly for a flexible fiber optic temperature probe.

FIG. 8 shows a block diagrams of example embodiments of methods of assembling a portion of a flexible fiber optic temperature probe.

FIG. 9 illustrates an example embodiment of a temperature sensing sub-assembly for use with a flexible fiber optic temperature probe.

FIG. 10 shows a block diagram showing an example embodiment of a method of measuring a desired area with an example flexible temperature probe.

FIGS. 11A-H show various views of example embodiments of flexible shielding for fiber optic bundles.

FIGS. 12A-12C show various cross-section views of examples embodiments of flexible fiber optic bundles.

FIG. 13A shows a partial cross-section view of an example embodiment of a flexible temperature probe.

FIG. 13B shows a cross-section view of an example embodiment of a flexible temperature probe assembled into a body.

FIG. 14 shows a cross-section view of an example embodiment of a temperature sensing sub-assembly.

FIG. 15 shows a partial cross-section view of an embodiment of a temperature sensing sub-assembly and a portion of a flexible member.

FIGS. 16A and 16B show cross-section views of various example embodiments of portions of a flexible temperature probe.

FIG. 17 shows a view of an example embodiment of a portion of a flexible temperature probe.

FIG. 18 shows a cross-section view of an example embodiment of a portion of a flexible temperature probe assembled into a body.

FIG. 19 shows a cross-section view of an example embodiment of a multi-point temperature sensing probe assembled into a body.

FIG. 20 shows a cross-section view of an example embodiment of a portion of a flexible temperature probe.

FIG. 21 shows a view of an example embodiment of a portion of a flexible temperature probe.

### DETAILED DESCRIPTION

Example embodiments are described herein with reference to the accompanying drawings. Unless otherwise expressly stated, in the drawings the sizes, positions, etc., of components, features, elements, etc., as well as any distances therebetween, are not necessarily to scale, and may be exaggerated for clarity. In the drawings, like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

The terminology used herein is for the purpose of describing particular example embodiments only and is not intended to be limiting. Unless otherwise defined, all terms (including technical and scientific terms) used herein have the same meaning as commonly understood by one of ordinary skill in the art. As used herein, the singular forms “a,” “an” and “the” are intended to include the plural forms as well, unless the context clearly indicates otherwise. Also, the terms “at least one”, “at least a”, and “one or more” may are intended to include both the singular and plural forms, depending on the context. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless indicated otherwise, terms such as “first,” “second,” etc., are only used to distinguish one element from another. For example, one coupler could be termed a “first coupler” and similarly, another coupler could be termed a “second coupler”, or vice versa.

Unless indicated otherwise, spatially relative terms, such as “below,” “beneath,” “lower,” “above,” and “upper,” “opposing,” and the like, may be used herein for ease of description to describe one element or feature's relationship to another element or feature, as illustrated in the FIGS. It should be recognized that the spatially relative terms are intended to encompass different orientations in addition to the orientation depicted in the FIGS. For example, if an object in the FIGS. is turned over, elements described as “below” or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly. A set of reference axes (e.g., X, Y, Z), directions, or coordinates, and the rotation around them (e.g., θX, θY, θZ) may be included in the FIGS. for the purpose of orienting the reader to facilitate understanding of the FIGS. and the specification, and do not necessarily indicate that any particular feature or element is aligned with, or is orthogonal to, any other feature or element.

The paragraph numbers used herein are for organizational purposes only, and, unless explicitly stated otherwise, are not to be construed as limiting the subject matter described. It will be appreciated that many different forms, embodiments and combinations are possible without deviating from the spirit and teachings of this disclosure and so this disclosure should not be construed as limited to the example embodiments set forth herein. Rather, these examples and embodiments are provided so that this disclosure will be thorough and complete, and will convey the scope of the disclosure to those skilled in the art.

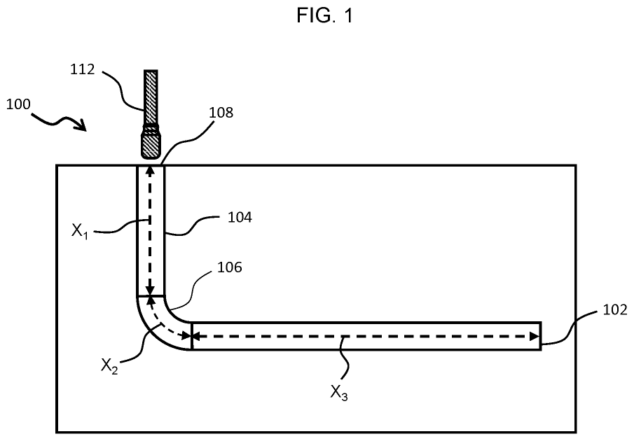

FIG. 1 illustrates a partial view of an example embodiment of a body 100 having at least one channel 104 with at least one opening 108 and at least one bend 106 formed therein and configured to allow at least one flexible temperature probe 112 (also referred to herein as the “temperature probe 112” or the “probe 112”) to be inserted into the body 100 in a non straight-line path. The channel 104 includes at least one surface 102 (also referred to herein as a “surface to be measured”, or a “target surface”), and in various applications measuring the temperature of the surface 102 is desirable. In various embodiments described herein, the body 100, the target surface 102, the channel 104 and the bend 106 may also be referred to as the “measurement region”. To measure the temperature of the target surface 102 (or any part of body 100), a temperature probe is positioned to engage or to substantially thermally communicate with the surface 102 (e.g., be located within a proximity such that a sensing element in the temperature probe provides a response to the temperature of the surface 102 or temperature variations at the surface 102). In some embodiments, the temperature at the surface 102 of the body 100 can be used as a proxy for a temperature of a desired area or region (e.g., a temperature in the middle of the body 100), and therefore a sensor or sensing element may desirably be placed in thermal communication with the surface 102 to measure the temperature of the surface 102.

The channel 104 includes at least one bend 106 and has a channel length X_{C} defined as the distance a probe needs to travel from the opening 108 of the channel 104 to the desired location (e.g., the surface 102). In this embodiment, the channel 104 includes a straight portion having a length X₁, a bend 106 having a length X₂, and another straight portion having a length X₃. The total channel length X_{C}=X₁+X₂+X₃. It is understood that the shown channel length X_{C} is illustrative, and the channel length X_{C} includes permutations of a probe traveling the length of the channel 104 other than directly. For example, the channel length X_{C} includes channel lengths where the probe has kinks or other types of variations that increase or decrease the length of probe required to contact the desired area.

The bend 106 can be of a variety of different sizes, and include a variety of different features, as will be discussed below. In at least one example embodiment, the body 100 includes multiple bends (not shown), however, for the sake of simplicity, this disclosure shall refer to scenarios where a single bend is encountered.

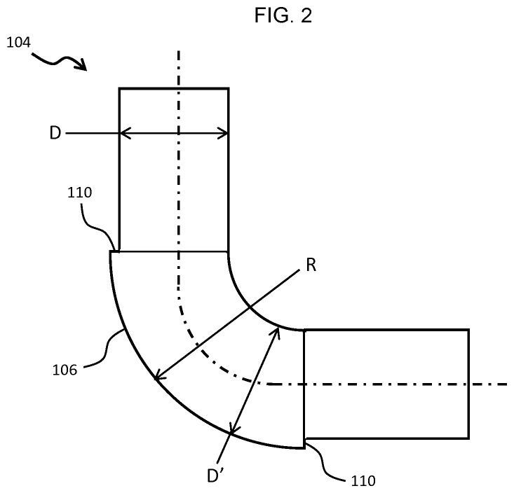

FIG. 2 illustrates an enlarged cross-section view of the channel 104 showing the bend 106 to highlight difficulties associated with inserting a flexible temperature probe into the bend 106. Accessing the surface 102 (shown in FIG. 1) of the body 100 with a temperature probe can be difficult, particularly where the bend 106 includes a small bend radius R (shown in an exaggerated manner for ease of reference), which in this embodiment is approximately 1″.

Similarly, as referred to above, the bend 106 can include one or more features which may impede a probe passing through the channel 104. For example, in the illustrated embodiment, the bend 106 includes variations that can obstruct a probe passing through. A variety of variations are contemplated by this disclosure. For example, in the illustrated embodiment, the variation is defined by a single step 110 which expands the channel 104, such that the variation is defined by a transverse dimension or diameter D′ that is greater than the transverse dimension or diameter D of the channel 104 in regions other than in the variation. A probe passing through the channel 104 could potentially be stopped from passing further into the channel 104 by the step 110.

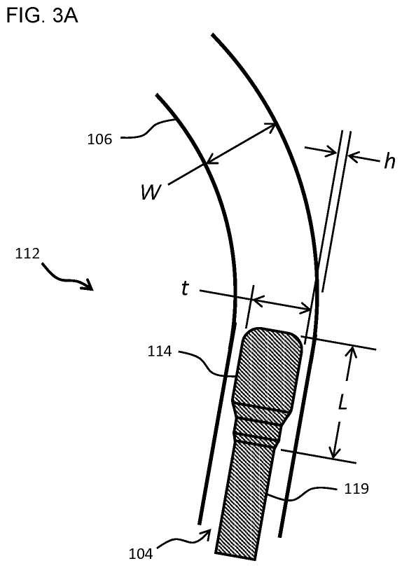

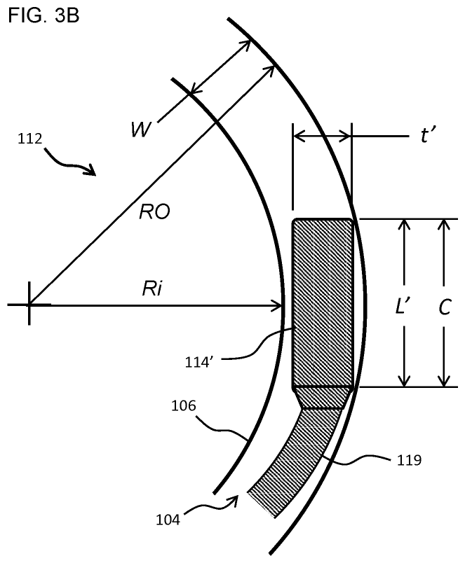

FIGS. 3A and 3B further illustrate difficulties associated with inserting a fiber optic temperature probe 112 (also referred to herein as the “temperature probe”, or the “probe”) into a channel 104 having a transverse dimension or width W. In the illustrated embodiment, the probe 112 includes a rigid or substantially rigid portion (e.g., a temperature sensing sub-assembly) 114 (also referred to herein as the “sensing sub-assembly 114”)) and a flexible or substantially flexible portion 119. The sensing sub-assembly 114 has a transverse dimension t (e.g., a diameter), and longitudinal dimension L (i.e., a length). FIG. 3A shows a radial clearance h between the transverse dimension t and the wall of the channel 104. Depending on the longitudinal dimension L and the transverse dimension t of the sensing sub-assembly 114, the radial clearance h may be small enough to make insertion of the probe 112 through the channel 104 difficult.

While FIG. 3A shows the sensing sub-assembly 114 having multiple diameters, in other embodiments the sensing sub-assembly 114 may be substantially cylindrical and have a single diameter, as shown as the rigid or substantially rigid portion 114′ (also referred to herein as the “sensing sub-assembly 114′”) in FIG. 3B.

In various embodiments, the flexible or substantially flexible portion 119 shown in FIG. 3A may comprise all or a portion of the flexible portion of the temperature probe 112. Referring to FIG. 3B, in the illustrated embodiment, the rigid portion 114′ has a longitudinal dimension or length L′ and a transverse dimension (i.e., diameter) t′ and the channel 104 has a bend 106 that has an outer radius of curvature RO, a inner radius of curvature Ri, and a resultant transverse dimension (i.e., width or diameter) (RO−Ri)=W. The length C is the chord of the curvature of the bend 106 of the channel 104 that the longitudinal dimension L′ of the rigid portion 114′ makes when contacting the wall at the outer radius RO of the bend 106 (note that L′=C) as shown in FIG. 3B and is related to the channel radii RO and Ri by:

$$C = 2 \times \sqrt{{RO}^{2} - {( R i + {t}^{′} )}^{2}} \qquad Equation 1$$

Solving for Ri+t′ gives

$$R i + {t}^{′} = \sqrt{{RO}^{2} - {( C / 2 )}^{2}} \qquad Equation 2$$

The minimum width Wmin of the channel 104 at the bend 106 is then given by RO−Ri:

$$W min = RO - \sqrt{{RO}^{2} - {( C / 2 )}^{2}} + {t}^{′} \qquad Equation 3$$

In various embodiments, the width W of channel 104 at the bend 106 must be equal to or greater than Wmin. The table below shows several example minimum dimensions of the width W of the channel 104 for different values of radius of curvature RO of the bend 106, the length L′ (or C) of the rigid portion 114′ and the width or diameter t′ of the rigid portion 114′.

| | | | | | |
|---|---|---|---|---|---|
| Length of rigid portion (L′ or C) (mm) | 20 | 15 | 15 | 10 | 10 |
| Diameter of rigid portion t′ (mm) | 3 | 3 | 2.5 | 3 | 2.5 |
| Outer radius of curvature RO (mm) | 100 | 100 | 100 | 150 | 150 |
| Minimum channel width Wmin (mm) | 3.5 | 3.3 | 2.8 | 3.1 | 2.6 |

In some embodiments, fabrication tolerances may need to be accommodated and in such embodiments, the minimum width Wmin of channel 104 may be no less than a multiple of about 1.03*Wmin, no less than about 1.05*Wmin, or no less than about 1.10*Wmin. In various embodiments, the maximum width of channel 104 may be about the length C or L′ of the rigid portion 114 or 114′, in order to prevent or minimize difficulties (e.g., bending, kinking, or folding of the flexible portion 119) with insertion and removal. In some embodiments, fabrication tolerances may need to be accommodated and in such embodiments the maximum width of channel 104 may be no less than about 1.03*(C or L) or no less than about 1.05*(C or L′) or no less than about 1.10*(C or L′).

While Equation 3 and the discussion with respect to Equation 3 provides a process for determining a minimum channel width given the outer radius of curvature, the rigid tip length L′, and rigid tip width or diameter t′, those skilled in the art will appreciate that Equation 3 may be re-arranged to solve for variables other than the minimum channel width, for example, the outer radius of curvature, the rigid tip length, or the rigid tip width or diameter.

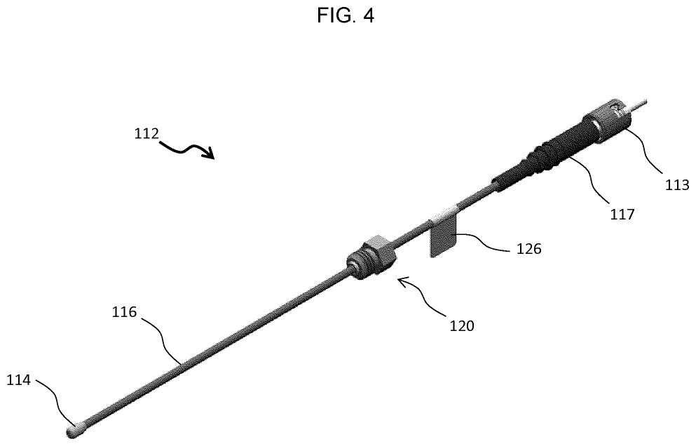

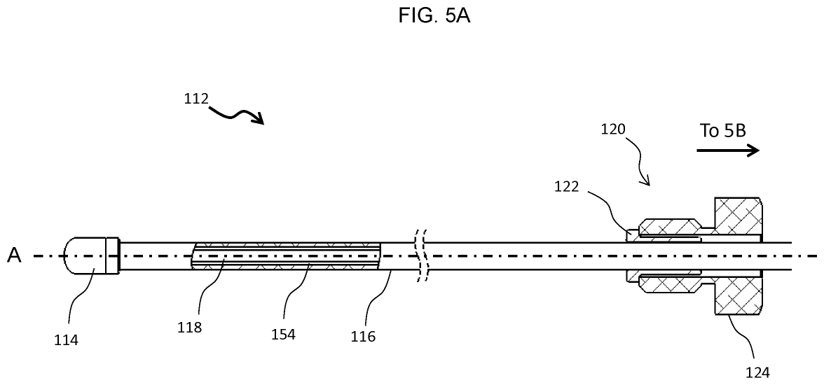

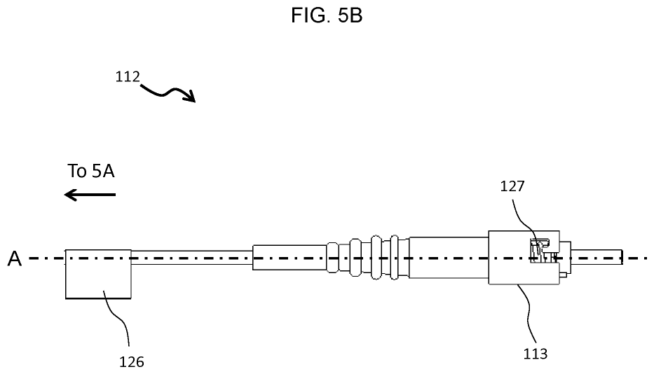

FIGS. 4, 5A and 5B show various views of an example embodiment of a flexible temperature probe 112. As shown in FIG. 4, probe 112 includes at least one temperature sensing sub-assembly 114 and at least one flexible jacket 116 that surrounds a plurality of flexible fiber optic elements 118 (also referred to herein as the “fiber optic elements 118”, or the “bundle of fiber optic elements 118”, or the “fiber bundle 118”) that has a first end and a second end. The probe 112 may further include at least one mount 120 for engaging the opening 108 of the channel 104 (shown in FIG. 1), at least one connector 113, and an optional strain relief 117. As will be described herein, the mount 120 can be used to configure the probe 112 to have the same or similar length X_{C} of the channel 104.

As shown in FIG. 5A, in the illustrated embodiment, the mount 120 includes at least one first part 122 (e.g., a retainer) and at least one second part 124 (e.g., a nut) that engages the first part 122 at least in part to retain the flexible jacket 116 within the second part 124. In the illustrated embodiment, the flexible jacket 116 includes at least one passage into which the plurality of fiber optic elements 118 can be inserted so that the plurality of fiber optic elements 118 is surrounded by the flexible jacket 116. For example, the flexible jacket 116 includes at least one passage 154. In some embodiments, the flexible jacket 116 is a tube into which the plurality of fiber optic elements may be inserted. In some embodiments, the jacket 116 is configured to be changed (e.g., shrunk when exposed to heat) to reduce the cross-sectional area of the passage 154 so that the inside diameter of the flexible jacket 116 is in contact with at least a portion of the plurality of fiber optic elements 118. The jacket 116 may be formed from a variety of materials, including, without limitation, polytetrafluoroethylene (PTFE), or any of a wide variety of polymers. The flexible jacket 116 may also include some fibrous elements (e.g., fiberglass) within the body of the flexible jacket 116. The probe 112 can include a label 126 containing various information regarding the probe 112 (e.g., part number, date of manufacture). The connector 113 may include at least one biasing mechanism 127 (e.g., a spring) to bias the sensing sub-assembly 114 towards a surface (e.g., the surface 102). The mechanism may be part of a standard straight tip (ST) connector at a connection end of the probe 112. Also shown in FIGS. 5A and 5B is an axis A, located at approximately at the center of the plurality of fiber optic elements 118. Hereinafter, the terms “outward” or “inward”, or similar terms, shall be used to denote radial directions relative to the axis A. For example, outward surfaces are further away from the axis A as compared to inward surfaces.

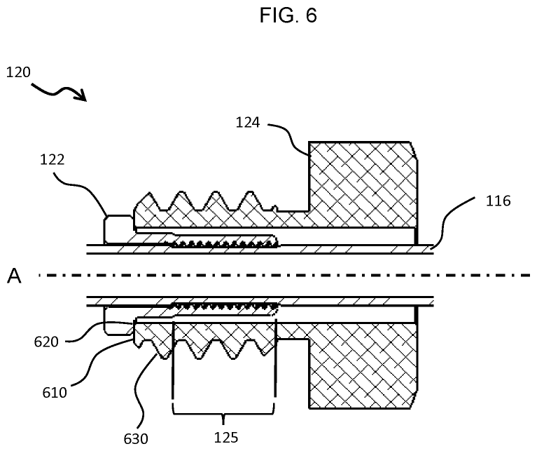

FIG. 6 shows an enlarged cross-sectional diagram of the example mount 120 shown in FIG. 5A for engaging the opening 108 of the channel 104 shown in FIG. 1. Similar to the sensing sub-assembly 114, as will be discussed herein, the inner mount part 122 may include a region 125 configured to be crimped onto the flexible jacket 116 to secure the inner mount part 122 to the flexible jacket 116. In various embodiments, once the inner mount part 122 is crimped onto the flexible jacket 116, the outer mount part 124 may be slid onto the flexible jacket 116 and a surface 610 of the outer mount part 122 may be disposed against a surface 620 of the inner mount part 122, after which the outer mount part 124 may be secured to the mounting body, such as the body 100 in FIG. 1. The embodiment shown in FIG. 6 shows the outer mount part 124 configured with screw threads 630 to be secured to the body 100, though those skilled in the art will appreciate that other connection features may be formed on the outer mount part 124. The properties of the sensing sub-assembly 114 (shown in FIG. 5A) can be adjusted to facilitate the probe 112 passing through the channel 104. For example, the sensing sub-assembly 114 can be configured with transverse dimension t and/or length L so that the sensing sub-assembly 114 is capable of passing through the transverse dimension or diameter D (shown in FIG. 2) of a smallest bend 106 in the channel 104.

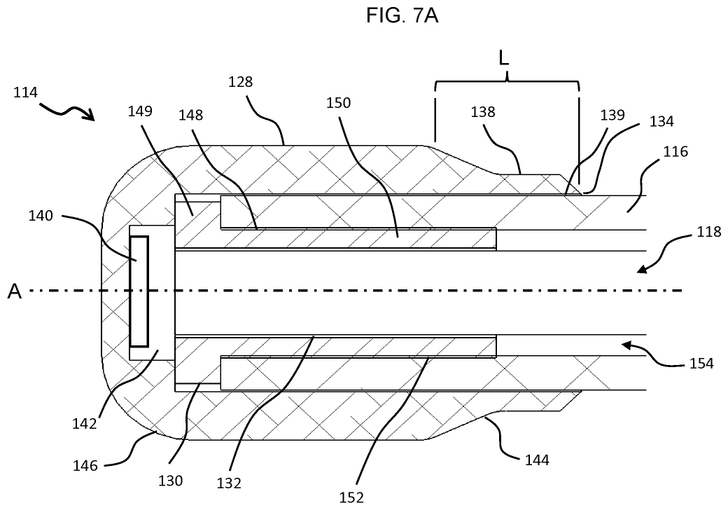

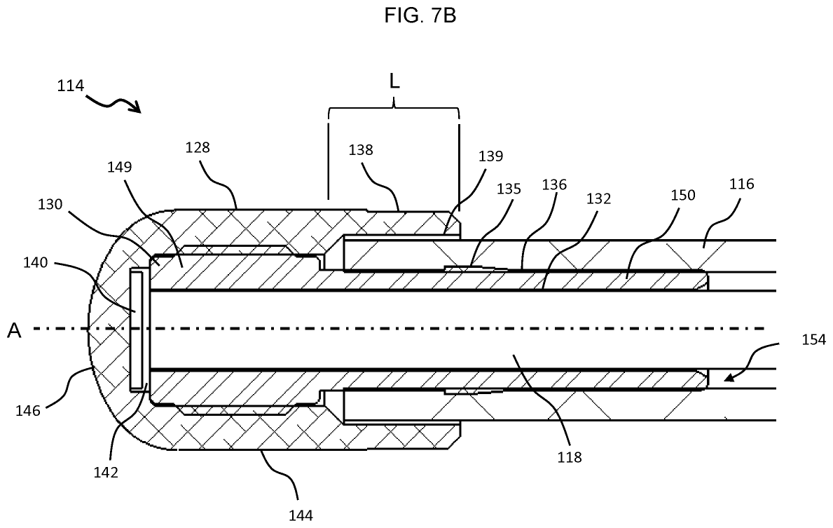

FIGS. 7A and 7B illustrate different example embodiments of the sensing sub-assembly 114. In the illustrated embodiments, the sensing sub-assembly 114 includes a first part or tip 128 and a second part or ferrule 130 disposed radially inward relative to the tip 128. In the illustrated embodiment, the tip 128 includes at least one tip part 138 having at least one inner diameter 139 sized to receive the flexible jacket 116 therein. In some embodiments, there is a clearance 134 between the inner diameter 139 and the flexible jacket 116. In other embodiments, there is no clearance 134 between the inner diameter 139 and the flexible jacket 116, thereby requiring some force to be applied to insert the flexible jacket 116 into the inner diameter 139. The ferrule 130 includes a first end (i.e., a head 149) and a second end (i.e., a tail 150) arranged axially opposed from each other along to an axis A. A passage 132 configured to receive the plurality of fiber optic elements 118 is formed in the ferrule 130. At least one recess 148 is formed in the ferrule 130. In the illustrated embodiment, the recess 148 allows the flexible jacket 116 to be placed between the interior surface of tip 128 and ferrule 130. The passage 132 is configured to receive and retain the plurality of fiber optic elements 118. The plurality of fiber optic elements 118 can be retained by the ferrule 130 in a variety of ways. For example, in one embodiment, the plurality of fiber optic elements 118 and the ferrule 130 may be adhered to one another with an adhesive that does not affect the optical performance of the plurality of fiber optic elements 118. In some embodiments, the ferrule 130 may be at least partially deformable, so that the ferrule 130 may be deformed to secure the plurality of fiber optic elements 118 within the passage 132. The portion of the plurality of fiber optic elements 118 that is secured to the ferrule 130 shall be understood to be the distal portion of the plurality of fiber optic elements 118. The tip 128 may be referred to alternatively as an exterior portion, and the ferrule 130 can be referred to as the interior portion.

In one embodiment, the tip 128 is threaded onto the ferrule 130. In other embodiments, the tip 128 is secured to the ferrule 130 at least partially with an overmold (e.g., a melt-processable or sintered fluoropolymer) or dip coat/potting compound. In other embodiments, the tip 128 and the ferrule 130 are secured to one another by adhesives. In still other embodiments, the tip 128 and the ferrule 130 are secured to one another via crimping. For example, the tip 128 can be crimped along a length L, plastically deforming the tip part 138 inwards, so that the deformed tip part 138 at least in part interferes with axial movement of the ferrule 130 relative to the tip 128. The tip 128 can be crimped at a location that overlaps the recess 148, securing the tip 128 to the ferrule 130.

In one embodiment, shown in FIG. 7B, the ferrule 130 can include a clearance 135 defined by an exterior surface 136 of the ferrule 130 sized to allow the flexible jacket 116 to slide over it. For example, the clearance 135 results from an outer diameter of the ferrule 130 and the inner diameter of the jacket 116. In example embodiments, the clearance 135 is defined by the outer diameter of the ferrule 130 relative to other parts of the ferrule 130. Where the tip 128 and the ferrule 130 are crimped together and there is a clearance 135, the crimping can secure the jacket 116 to the tip 128 or the ferrule 130 or both.

In the illustrated embodiment, the tip 128 includes a sensing element 140. The sensing element 140 can include one or more phosphors, or other material(s) suitable for temperature measurement. In the illustrated embodiment, the sensing element 140 is disposed within a cavity 142 formed in the tip 128. The sensing element 140 can be secured to the interior of the tip 128 in a variety of ways (e.g., adhesive bonding, mechanical fastening, or overmolding, etc.). The tip 128 and the ferrule 130 are securable to one another such that the sensing element 140 is in optical communication with the distal ends of the fiber optic elements 118.

In the illustrated embodiment, the exterior profile of the tip 128 is defined in part by a proximal contour 144 and a distal end contour 146, and can be configured or selected based on expected properties of the channel 104 and the bends 106 therein. For example, the sensing element 140 of FIG. 7B can be selected for use in applications being installed in a situation having a smaller expected bend 106, as the distal end contour 146 of FIG. 7B is slimmer compared to the similar distal end contour 146 of the tip 128 shown in FIG. 7A.

Similarly, and in example embodiments, complementary to the configuration of the tip 128, the ferrule 130 can be configured based on expected properties of the channel 104 and the bends 106 therein. For example, a head 149 of the ferrule 130 (in contrast to a tail 150) can have a radial thickness that permits passage through the expected diameter D of the channel 104 when secured to the tip 128, or a length that permits passage through the expected radius R of the bend 106.

Also illustrated in FIG. 7A an embodiment in which the tail 150 can have an outer diameter such that, for example, when the jacket 116 is slid over the tail 150 to secure the jacket 116 to the tail 150, a clearance 152 between the jacket 116 and the tail 150 of the ferrule 130 is formed. Moreover, similar to the mount 120, the ferrule 130 as a whole, or the tail 150, or the head 149, can have a radial thickness that varies across different axial portions of the ferrule 130.

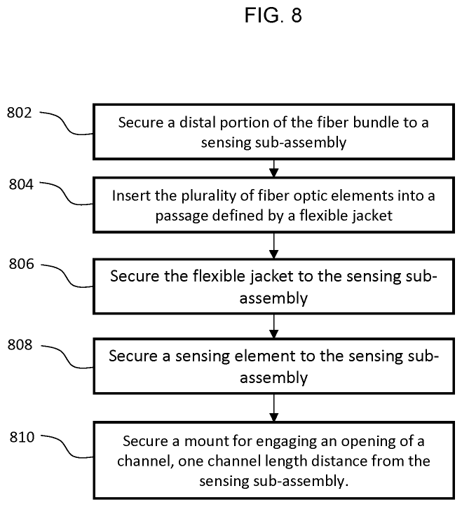

FIG. 8 shows a block diagram of an example method of assembling at least a portion of a flexible temperature probe 112. At block 802, distal portions of the plurality of fiber optic elements 118 (also referred to herein as the “fiber bundle 118”) are secured to a portion of the sensing sub-assembly 114 (e.g., the ferrule 130 of the sensing sub-assembly 114). In one embodiment, securing distal portions of the fiber bundle 118 includes inserting the distal portions of the fiber bundle 118 through the passage 132 of the sensing sub-assembly 114 and securing the fiber bundle 118 to the flexible jacket 116. At block 804, the fiber bundle 118 is inserted within a passage 154 shown in FIG. 7B) defined by the flexible jacket 116. At block 806 the flexible jacket 116 is secured to the sensing sub-assembly 114. For example, the flexible jacket 116 can be secured to the sensing sub-assembly 114 via a crimping process. The crimping can be performed at or approximate to the recess 148, where prior to crimping the flexible jacket 116 is overlayed over the recess 148, and the crimping secures the flexible jacket 116 to the tip 128. In example embodiments, the flexible jacket 116 is overlayed over the recess 148 and further overlays a portion of the tip 128, such that the crimping secures the flexible jacket 116, the tip 128, and the ferrule 130 to each other.

In example embodiments, similar to the connection between the tip 128 and the ferrule 130, the flexible jacket 116 can be secured to the sensing sub-assembly 114 via an overmold (e.g., a melt-processable or sintered fluoropolymer) or dip coat/potting compound. Some fluoropolymers like perfluoroalkoxy alkanes (PFA) are melt-processable and PFA could be an alternate material for the jacket 116. In other embodiments, the flexible jacket 116 can be secured with a friction fit with the ferrule 130 through the application of force. As discussed above, in some embodiments, the flexible jacket 116 is secured to the ferrule 130 via a combination of one or more of adhesion, crimping, or other means.

At block 808, and wherein block 802 included attaching fiber optic elements 118 and the flexible jacket 116 to a sensing sub-assembly 114 without a sensing element 140 (i.e., unassembled), the tip 128 having the sensing element 140 of the sensing sub-assembly 114 secured to the ferrule 130, completing assembly of the sensing sub-assembly 114. In some embodiments, the tip 128 is removably attached to the ferrule 130, for example, via a threaded connection, (not shown).

At block 810, a mount 120 for engaging an opening 108 of the channel 104, a channel-length distance (i.e., the length X_{C}=X₁+X₂+X₃ of the channel 104 shown in FIG. 1) from the sensing sub-assembly 114 is secured to the jacket 116. In various embodiments, parts 122 and 124 (a retainer and nut, respectively) shown in FIGS. 4 and 5A may be slid onto the jacket 116, passing over the sensing sub-assembly 114 and the retainer 122 may be secured to the jacket by crimping, and the subsequent deformation of the retainer 122.

In various embodiments, a flexible temperature probe may include all or some of the steps shown in FIG. 8 and the steps may occur in different sequences than shown in FIG. 8 as well as include other optional steps, for example, securing a connector and optional strain relief to the proximal end of the fiber bundle and jacket or attaching a label to the flexible temperature probe.

Those skilled in the art will appreciate that while throughout this disclosure the sensing sub-assembly 114 has been described as being composed of separate parts, one or more of the constituent parts, or the entire sensing sub-assembly 114, may be provided as a single part. The sensing sub-assembly 114 can also include various monolithic combinations of the described constituent parts. For example, the tip 128 and the ferrule 130 may be combined to form a monolithic sensing sub-assembly 114.

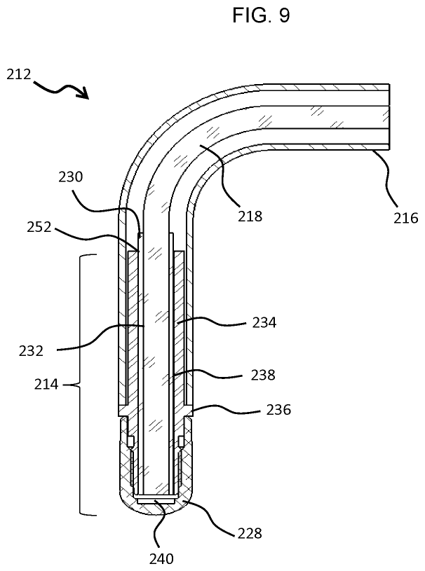

FIG. 9 illustrates an example embodiment of a flexible temperature probe 212 that is assembled in a pre-bent tube or other type of passage or jacket that is configured to be installed in a wide variety of end-use devices. The probe 212 includes a bundle of flexible fiber optic elements 218 (i.e., a “fiber bundle 218”), at least one passage, jacket, or pre-bent tube 216, and a sensing sub-assembly 214. In the illustrated embodiment, the sensing sub-assembly 214 includes at least one collar (e.g., an inner ferrule 230), at least one tip 228 including at least one sensing element 240, and at least one intermediary part (e.g., an outer ferrule 234). The inner ferrule 230 includes at least one internal passage 232 for receiving the fiber bundle 218. Similar to the ferrule 130, the inner ferrule 230 is secured to end portions of the fiber bundle 218 within the internal passage 232. In some embodiments, the inner ferrule 230 is a separate part from the sensing sub-assembly 214. For example, the end portions of the fiber bundle 218 can be secured to the inner ferrule 230 (e.g., via gluing) prior to the inner ferrule 230 being secured to the sensing sub-assembly 214. The inner ferrule 230 can be glass, to at least in part address concerns related to the optical performance of the fiber bundle 218, or to address concerns about heat dissipation, or to match the thermal expansion of the fiber bundle 218, as discussed herein.

In at least one example embodiment, the end portions of the fiber bundle 218 can be secured to the inner ferrule 230, and the inner ferrule 230 is passed through the passage defined by jacket 216 to an opening. The inner ferrule 230 is thereafter secured to outer ferrule 234, which itself includes an internal passage 238 sized to receive the inner ferrule 230. The outer ferrule 234 can be a rigid metal part, and the inner ferrule 230 can be secured to the outer ferrule 234 via, for example, glue or other attachment mechanisms. In some embodiments, for example, the inner ferrule 230 and the outer ferrule 234 are secured at a portion 252 of the outer ferrule 234 which is distant from projections (as described herein) formed on the outer ferrule 234, as said projections may be subject to thermal loading which can potentially adversely impact the securing means. In other embodiments, the outer ferrule 234 at portion 252 includes a funnel configuration to facilitate receiving the inner ferrule 230 into the passage 238.

In some embodiments, the outer ferrule 234 includes one or more projections 236 that are capable of being secured to the jacket 216. The projections 236 can be secured to an adjacent portion of jacket 216 by, for example, laser welding of an outer surface of the projection 236 to the adjacent portion of the jacket 216, or via gluing, etc. Securing the outer ferrule 234 to the adjacent portion of jacket 216 via the projections 236 closes the opening in the jacket 216. In this way, the environment within the jacket 216 may be isolated from the environment outside of the sensing sub-assembly 214.

The projections 236 may fit within the passage defined by the jacket 216 through which the bundle 218 is passed, or as shown in FIG. 9, the projections 236 can prevent at least one part of the outer ferrule 234 from being insertable within the passage defined by the jacket 216. Where the projections 236 cannot be inserted, advantageously the outer ferrule 234 can be secured to the inner ferrule 230 a distance away from the possibly cramped location of the opening in the jacket 216 for assembly, and the secured inner ferrule 230 and the outer ferrule 234 can thereafter be placed to close the opening in the jacket 216 with the projections 236.

The sensing element 240 can be secured to an inner surface of the tip 228 so that the sensing element 240 is in optical communication with the distal ends of the fiber bundle 218, as shown. The tip 228, the outer ferrule 230, and the fiber bundle 218 can be secured in a variety of manners. For example, the tip 228 and the outer ferrule 234 can be removably attached, via a threaded engagement, or secured via an adhesive, etc. In some embodiments, the sensing element 214 and the outer ferrule 234 are formed monolithically.

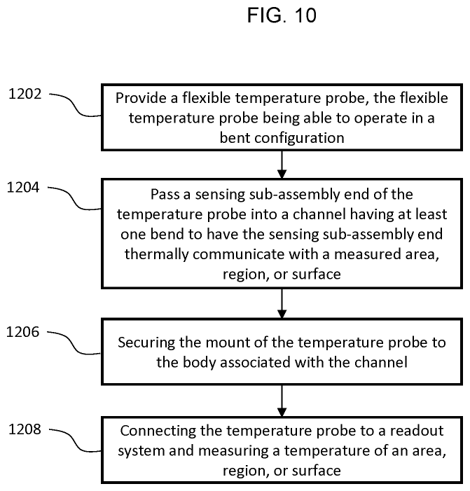

FIG. 10 shows a block diagram of an example embodiment of a method of measuring the temperature of a desired area, region or surface with an example flexible temperature probe. The method of FIG. 10 shall be discussed with reference to the probe 112 for ease of illustration. At block 1202, the flexible temperature probe 112 that can operate within a bent configuration is provided. The bent configuration can be defined by the bend 106 with the smallest radius bend in a channel 104 into which the probe 112 is being installed (see FIG. 1).

At block 1204, the sensing sub-assembly 114 of the temperature probe 112 is passed through a channel (e.g., the channel 104) having at least one bend (e.g., the bend 106) so that the sensing sub-assembly 114 thermally communicates with the desired area, region, or surface. In example embodiments, the desired area is a surface (e.g., surface 102 of FIG. 1). Passing the sensing sub-assembly 114 through the channel 104 can include inserting and passing the sensing sub-assembly 114 past any obstructions or variations before insertion into the channel 104 (as shown in FIG. 2). In some embodiments, there is a top plate (not shown) above the opening 108 in the channel 104 shown at the top of the image in FIG. 1. As noted, the sensing sub-assembly 114 can be configured or selected based on the properties of the channel 104 and bend 106 (e.g., the sensing sub-assembly 114 of FIG. 3A vs. the sensing sub-assembly 114′ shown in FIG. 3B) may be selected, as it may be able to bend around a smaller bend radius, which makes it easier to avoid obstructions and variations).

At block 1206, the mount 120 is secured to the body associated with the passage, for example, the body 100 associated with the channel 104 shown in FIG. 1. At block 1208, the flexible temperature probe is connected to a readout system or converter which is operatively configured to measure a temperature of an area, region, or surface.

In various embodiments, the flexible jacket 116 may be utilized to surround the plurality of fiber optic elements 118, for example, to constrain them to a certain diameter to ease passage of flexible temperature probe 112 through a channel, for example, the channel 104. The flexible jacket 116 may be utilized to provide protection of the plurality of fiber optic elements 118, for example, to protect them from abrasion, scratching or breaking while the flexible temperature probe 112 is inserted or removed from a channel or while it is in operation.

The material or materials of the flexible jacket 116 may be selected to provide one or more characteristics, for example, to provide sufficient flexibility to be able to be inserted and removed from a channel, to provide protection for the plurality of the fiber optic elements 118 or to ease passage of the flexible temperature probe 112 though a channel, for example, to have a low coefficient of friction between the flexible jacket material 116 and the material or materials of construction of the channel. In various embodiments, the material or materials of the flexible jacket 116 may be selected to meet the thermal and other environmental conditions expected during operation. For example, high temperature operation may require materials of construction different from those used for low temperature operation. In addition to thermal requirements, the material or materials of the flexible jacket 116 may be selected to provide resistance to stray light and/or diffusion or permeation of gasses through the flexible jacket 116, for example, for use in environments that may be corrosive to the plurality of fiber optic elements 118, or the material or materials of the flexible jacket 116 may be selected to provide a vacuum seal between the inner portions of flexible temperature probe 112 and the operating environment.

In various embodiments, the flexible jacket 116 may be formed of one or more materials including polymers such as polytetrafluoroethylene (PTFE), polyvinyl chloride (PVC), polyethylene, PAI, PI, PEI, PEEK, PTFE, PFA or the like. In other embodiments the flexible jacket 116 may be formed of other materials, for example metals such as aluminum, stainless steel, titanium, nickel, gold, silver, alloys of metals or the like, or fibers such as silica or other materials. The materials of construction of the flexible jacket 116 are not a limitation of the present disclosure.

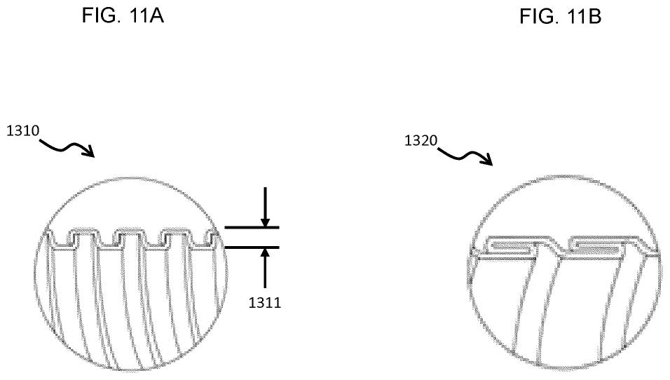

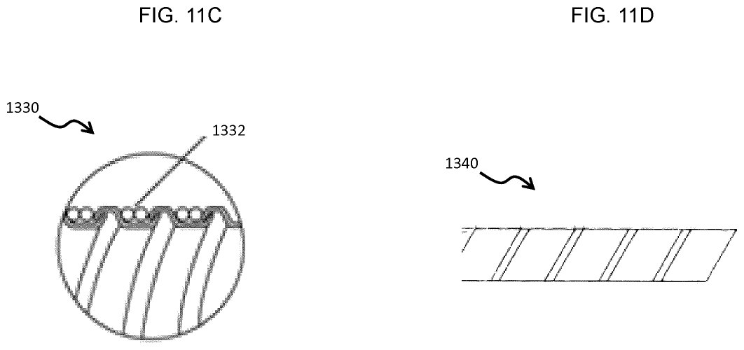

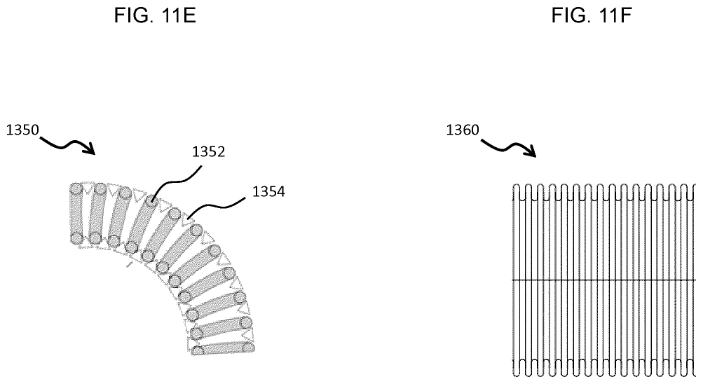

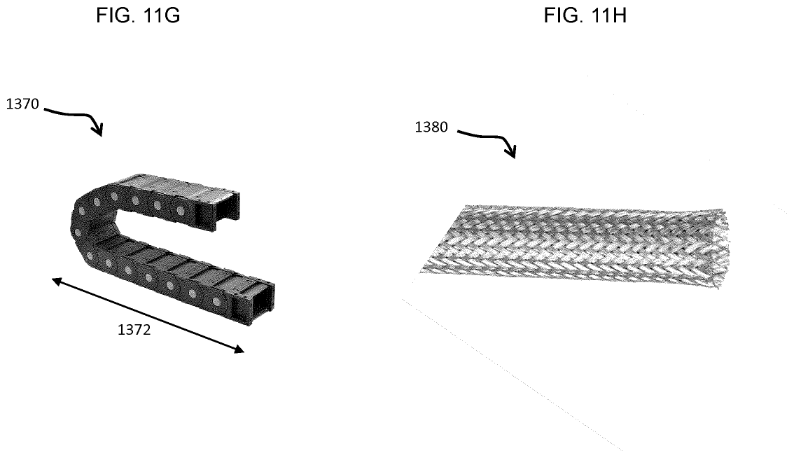

In some embodiments, the flexible jacket 116 may be formed of metal in a variety of different configurations to achieve different characteristics, for example, flexibility, stiffness, protection, ease of insertion and removal from a passage, or the like or any combination thereof. FIGS. 11A through 11H depict example cross-sections of metal flexible jackets, however, in other embodiments such configurations may be utilized with materials other than metal.

FIG. 11A shows an example cross-section view of a portion of a squarelock construction flexible jacket 1310. In various embodiments, the squarelock flexible jacket 1310 may be produced from a continuous metal strip which is locked into position by one overlapping joint. In various embodiments the overlapping joint may prevent stretching of the flexible jacket 1310 which may allow configuration, in conjunction with the tip and mount construction, of a system that prevents or minimizes stretching of the optical fibers in the fiber bundle 118, for example, stretching along the length of the optical fibers and/or possible damage to the optical fibers or modification of optical properties of the optical fibers (e.g., due to stress and strain). In various embodiments, the squarelock construction may have a surface relief 1311, for example, as measured between the lowest point and the highest point in a direction perpendicular to the length of the flexible jacket less than about 2 mm, or less than about 1 mm, or less than about 0.8 mm, or less than about 0.5 mm, or less than about 0.2 mm.

FIG. 11B shows an example cross-section view of a portion of an interlock joint construction flexible jacket 1320. In some embodiments, the interlock joint construction may provide a more robust construction than the squarelock construction, for example, the ability to better withstand twisting, pulling and repeated bending. In various embodiments, the interlock joint construction may have an outer surface with a smaller variation in surface relief, and/or providing a smoother outer surface, as can be seen in reference to FIG. 11B, relative to, for example, the construction depicted in FIG. 11A, which may allow easier insertion and removal of the flexible probe into the desired passage. The overlapping joints may prevent stretching of the flexible jacket 1320 which may allow configuration, in conjunction with the tip and mount construction, of a system that prevents or minimizes stretching of the optical fibers, for example, stretching along the length of the optical fibers and/or possible damage to the optical fibers or modification of optical properties of the optical fibers (e.g., due to stress and strain).

FIG. 11C shows a cross-section view of a portion of an example embodiment of a bend-limiting construction flexible jacket 1330. In various embodiments, the bend-limiting construction may include one or more wires 1332 which may act to limit the radius of curvature of the flexible jacket 1330. In various embodiments, this may be used where it is required to impose a minimum radius of curvature, for example to prevent an enclosed fiber optic cable from exceeding its bending specification. In various embodiments, this bend-limiting construction may prevent stretching of the jacket 1330 which may allow configuration, in conjunction with the tip and mount construction, of a system that prevents or minimizes stretching of the optical fibers, for example stretching along the length of the optical fibers and/or possible damage or modification of optical properties of the optical fibers (e.g., due to stress and strain).

FIG. 11D shows a cross-section view of a portion of an example embodiment of a monocoil-construction flexible jacket 1340. In various embodiments, the monocoil construction does not include interlocking sections and may provide relatively higher flexibility relative to the embodiments shown in FIGS. 11A-11C. In various embodiments, the monocoil construction may allow stretching in the longitudinal direction (along the length of the optical fibers).

FIG. 11E shows a cross-section view of a portion of an example embodiment of a goose-neck construction flexible jacket 1350. In various embodiments, such a goose-neck construction may allow the flexible jacket 1350 to be bent into a given position and then hold this position without additional support. FIG. 11E shows one embodiment of a goose-neck construction, incorporating round portions 1352 of the cross-section and triangular portions 1354 of the cross-section, however, in other embodiments other configurations may be utilized.

FIG. 11F shows a cross-section view of a portion of an example embodiment of a bellows construction flexible jacket 1360. In various embodiments, a bellows construction may provide a seal between the interior portion and the exterior portion of the flexible jacket 1360. For example, in various embodiments, the bellows configuration flexible jacket 1360 may be utilized in conjunction with other components to provide a vacuum-tight barrier (positive relative pressure) or gas-tight barrier (negative relative pressure) between the interior and exterior environments of the flexible jacket 1360. Any of the flexible jacket constructions described above with respect to FIGS. 11A-11F may be formed from non-metallic materials, including thermoplastic or thermoset polymers, or composite materials (as describe herein with respect to FIG. 11H). Those skilled in the art will appreciate that any of a wide variety of materials or combinations thereof may be used to form the flexible jacket in order to have properties that provide acceptable performance with a wide variety of attributes regarding stiffness, flexibility, bending strength, opacity, thermal insulation or thermal protection, abrasion resistance, hydrophobic properties, ability to be autoclaved, to provide sealing between atmospheres of interior vacuum, exterior vacuum, high pressure. The jacket materials may also be selected based on their resistance to corrosive or reactive chemicals in various states of matter (e.g., liquid, solid, gaseous and plasma), or they may be selected based on their dielectric properties in order to avoid disturbing the flux of localized RF environments, or to prevent the generation of electrical currents or magnetic flux due to the presence of electric or magnetic fields.

FIG. 11G shows a cross-section view of a portion of an example embodiment of a drag-chain type construction flexible jacket 1370. In various embodiments, a drag-chain type construction may be utilized when it is desirable to limit the motion of the flexible jacket 1370 in one dimension. For example, the flexible jacket 1370 may move easily in a direction 1372 (along the length of the chain) but not move easily in a direction perpendicular to the direction 1372.

FIG. 11H shows a cross-section view of a portion of an example embodiment of a braided or woven construction flexible jacket 1380. In various embodiments, the density of braiding may be modified, for example to achieve different levels of flexibility and/or to achieve different levels of protection. In various embodiments, the braided construction may have a relatively smooth outer surface with relatively little variation in surface relief, and/or providing a smoother inner surface, which may allow easier insertion and removal of the flexible probe into the desired passage. In various embodiments, the braided construction may prevent stretching of the jacket which may allow configuration, in conjunction with the tip and mount construction, of a system that prevents or minimizes stretching of the optical fibers, for example stretching along the length of the optical fibers and/or possible damage or modification of optical properties of the optical fibers (e.g., due to stress or strain). The braided construction shown in FIG. 11H may include any of a wide variety of materials. For example, in some embodiments, the fibers that form the braid or weave may be made of a variety of metals, such as aluminum, steel, stainless steel, or the like or any combination thereof. In other embodiments, the fibers that form the braid or weave may be provided as alumina, zirconia, silica or glass fibers, glass fibers in a resin matrix (e.g., fiberglass), or carbon fibers, carbon fibers in a resin matrix (i.e., carbon fiber), aramid fibers (i.e., Kevlar) or aramid fibers in a polymer or resin matrix, or a phenolic construction. These fibers and their matrix materials may be formulated to provide for varying degrees of temperature resistance or thermal insulation to protect the optical fiber bundle (e.g., in extremely high temperature or cryogenic temperature applications). Those skilled in the art will appreciate that all of the flexible jacket configurations described herein may comprise or include any of the materials (or combinations thereof) as described throughout his disclosure.

In various embodiments, the example embodiments of flexible jacket constructions depicted in FIGS. 11A-11H may be constructed of one or more layers of a polymer, metal, synthetic or natural fiber, silica or the like. The material of construction is not a limitation of the present disclosure. In various embodiments the surface relief of various flexible jacket constructions of the present disclosure, for example as measured between the lowest point and the highest point in a direction perpendicular to the length of the flexible jacket, may be less than about 2 mm, or less than about 1 mm, or less than about 0.5 mm, or less than about 0.2 mm.

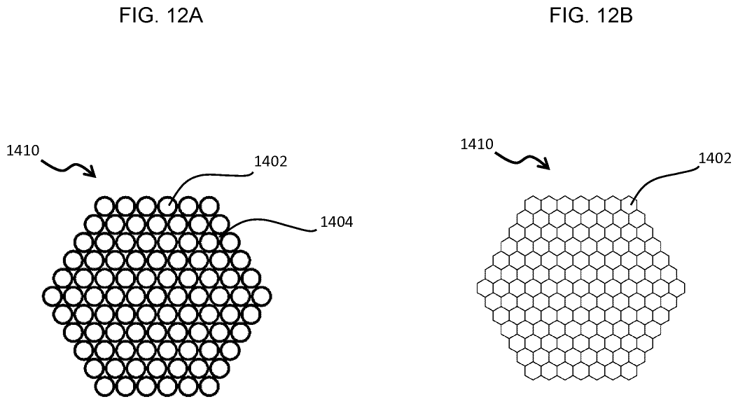

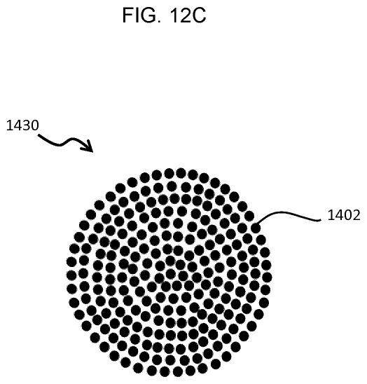

FIG. 12A shows an example cross-section of a flexible fiber optic bundle 1410. In various embodiments, the flexible fiber optic bundle 1410 may include multiple individual optical fibers 1402. In various embodiments, the flexible fiber optic bundle 1410 is encased in a jacket (not shown) to hold the fibers together and each individual fiber 1402 is not attached or adhered to any other individual fiber 1402, and may be at least partially separated from adjacent individual fibers 1402 by a space 1404. In various embodiments, when the flexible fiber bundle 1410 is bent or twisted, each individual fiber 1402 may slide relative to the other individual fibers 1402, thereby providing the flexibility of the overall fiber optic bundle 1410.

FIG. 12A shows the individual fibers 1402 arranged in a hexagonal array, however, in other embodiments the individual fibers 1402 may be configured in other arrays, such as a rectangular or square array, or the individual fibers may be assembled in a random array. In various embodiments, each individual fiber 1402 may have a diameter in the range of about 10 μm to about 500 μm, or in the range of about 20 μm to about 100 um, however the diameter of each individual fiber is not a limitation of the present disclosure. In various embodiments, each fiber optic bundle 1410 may include about 5 to about 1500 individual fibers 1402, or may include about 20 to about 200 individual fibers 1402, however the number of individual fibers 1402 in the fiber optic bundle 1410 is not a limitation of the present disclosure. In various embodiments, the number of fibers may be chosen to optimize the packing fraction within a jacket encasing the fiber optic bundle 1410.

In various embodiments of the present disclosure, the fiber optic bundle may have a minimum radius of curvature in the range of about 2 mm to about 100 mm, or in the range of about 10 mm to about 50 mm, however the minimum radius of curvature is not a limitation of the present disclosure.

In various embodiments, one or more portions of the individual fibers 1402 may be attached to other individual fibers. In various embodiments, the individual fibers may be adhered together, for example, with an adhesive that may fill some or all of the spaces 1404 between the individual fibers 1402. In various embodiments, one or more portions of the individual fibers 1402 may be fused to each other, for example, as shown in FIG. 12B. As shown in FIG. 12B the spaces between individual fibers 1402, identified as 1404 in FIG. 12A, have been minimized or eliminated. In various embodiments, the fusing process may include heating a portion of the flexible fiber bundle 1410 to fuse the individual fibers to each other, however this is not a limitation of the present disclosure and in other embodiments some or all of the individual fibers may be adhered to each other with an adhesive, epoxy, sealing glass (e.g., frits) or by other methods. In various embodiments, attaching or fusing the fibers may be done at one or both ends of the flexible fiber bundle 1410, for example, to simplify attachment to the flexible fiber optic bundle 1410 and/or to improve optical coupling into the flexible fiber optic bundle 1410, and optionally at other positions along the length of the flexible fiber optic bundle.

In various embodiments, the individual fibers may be configured so that the position of each individual fiber relative to other fibers is the same on each end of the fiber bundle, such that an image may be transmitted through the fiber, for example, a coherent optical fiber, however, in other embodiments the individual fibers may have different positions relative to each other at each end.

While the fiber optic bundles shown in FIGS. 12A and 12B have an overall approximately hexagonal shape or outline, in other embodiments the fiber optic bundles may have other overall shapes or outlines, such as a circular shape of a fiber bundle 1430 shown in FIG. 12C. Also, while FIGS. 12A-12C show all individual fibers 1402 as having the same diameter, in other embodiments the individual fibers may have different diameters within one fiber bundle. In various embodiments, each flexible fiber optic element may be able to be bent to have a minimum radius of curvature of less than about 100 mm, less than about 50 mm, less than about 25 mm, less than about 10 mm, or less than about 2 mm. In various embodiments, the flexible bundle of fiber optic elements may be able to be bent to have a minimum radius of curvature of less than about 100 mm, less than about 50 mm, less than about 25 mm, less than about 10 mm, or less than about 3 mm. In various embodiments, the assembly of the flexible jacket and the flexible bundle of fiber optic elements may be able to be bent to have a minimum radius of curvature of less than about 100 mm, less than about 50 mm, less than about 25 mm, less than about 10 mm, or less than about 3 mm. In various embodiments, the flexible jacket may be able to be bent to have a minimum radius of curvature of less than about 100 mm, less than about 50 mm, less than about 25 mm, less than about 10 mm, or less than about 3 mm.

While most of the discussion herein has included a flexible bundle of fiber optic elements enclosed or partially enclosed in a flexible jacket, this is not a limitation of the present disclosure and in other embodiments a flexible bundle of fiber optic elements may be used without a jacket or may be used with only one or more portions of the flexible bundle of fiber optic elements covered, enclosed or partially enclosed in a flexible jacket. In various embodiments, one or more portions of the flexible bundle of fiber optic elements may be constrained to simplify handling, insertion, and removal from a channel. In various embodiments, one or more portions of the flexible bundle of fiber optic elements may be constrained by a variety of means, for example using one or more mechanical constraints, for example a wire or band around the flexible bundle of fiber optic elements, using an adhesive, epoxy, sealing glass or glue, by fusing all or a portion of the individual fibers together or the like. The method of constraint is not a limitation of the present disclosure.

In various embodiments, the flexible temperature probe may be configured or constructed of materials allowing operation in a temperature range between about −200° C. and about 1000° C., or in a range between about −100° C. and about 750° C.

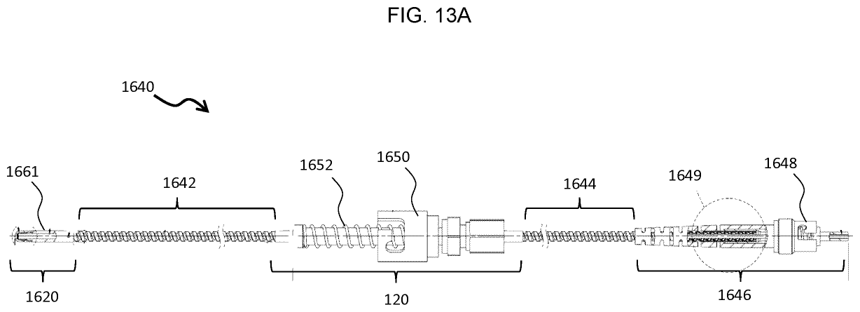

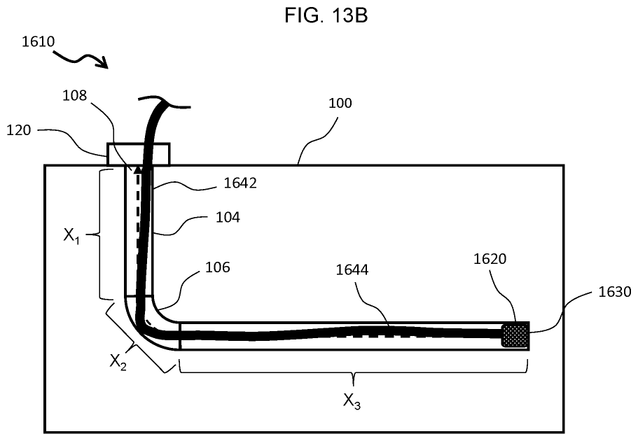

In various embodiments, the mount 120 (shown in FIG. 4) may be configured to attach to a mounting surface or body (e.g., the body 100) using a variety of methods, for example using a screw thread, a flange mount or a bayonet mount (e.g., as provided as the coupling 1650 described herein with respect to FIG. 13A, or any of a wide variety of optical fiber connectors or fiber bundle connectors). The configuration of the mount 120 is not a limitation of the present disclosure. In various embodiments, the mount 120 may be configured to be fixed in a specific position along the flexible portion of the temperature probe. In various embodiments, the mount 120 may be fixed to a position along the length of the temperature probe, for example along a portion of the flexible portion of the temperature probe. In various embodiments, the mount may be fixed to a position along the length of the temperature probe to ensure a desired insertion depth into the channel or to ensure a desired positioning of the sensing tip or element.

FIG. 13A shows an example embodiment of a flexible temperature probe 1640. In the illustrated embodiment, the probe 1640 includes a mount 120, a sensing sub-assembly 1620 (analogous to the sensing sub-assembly 114 described in reference to FIGS. 3A and 3B), a connector assembly 1646 including a connector 1648 and an optional strain relief 1649, a first flexible portion 1642 disposed between the mount 120 and the sensing sub-assembly 1620, and a second flexible portion 1644 disposed between mount 120 and the connector assembly 1646. While FIG. 13A shows a second flexible portion 1644, in other embodiments the second flexible portion 1644 may be omitted. In the illustrated embodiment, the sensing sub-assembly 1620 includes a tip 1661 configured to be placed in thermal communication with a target surface.

The mount 120 includes a coupling 1650 and an optional biasing member (e.g., a spring 1652). In the illustrated embodiment, the coupling 1650 is depicted as a bayonet-type fastener, though those skilled in the art will appreciate that in other embodiments the coupling 1650 may include or incorporate a flange-type fastener, a screw-type fastener or the like. In one embodiment, the first flexible portion 1642 and the second flexible portion 1644 may have lengths in the range of about 10 mm to about 5,000 mm, though in other embodiments, the length of the first flexible portion 1642 and the second flexible portion 1644 may have any length.

In various embodiments, the spring 1652 may be used, for example in conjunction with the coupling 1650, when attached to a mounting surface or the body 100, to ensure that a specific force or range of forces is applied by the tip 1661 of the sensing sub-assembly 1620 to the target surface where the temperature is to be measured (not shown in FIG. 13A). In various embodiments, the force between the tip 1661 and the target surface may be in the range of about 1 N to about 20 N or in the range of about 3 N to about 10 N. Those skilled in the art will appreciate that the force exerted can be any amount.

While FIG. 13A shows the spring 1652 as part of the mount 120, in other embodiments the spring 1652 may be positioned in other locations between the mount 120 and the sensing sub-assembly 1620, for example, at the interface between first flexible portion 1642 and the sensing sub-assembly 1620. Those skilled in the art will appreciate that the spring 1652 may be located anywhere on the probe 1640.

While FIG. 13A depicts the use of the spring 1652 to ensure a specific force between the sensing sub-assembly 1620 and the target surface, this force may be achieved using other biasing devices. For example, the spring 1652 may be replaced by a different compliant member, for example, a polymeric member or feature that compresses upon mating the coupling 1650 to the body 100. In various embodiments, the length of the first flexible portion 1642 may be adjusted such that it is longer than the axial channel length, for example, to ensure that the end or tip 1661 is in contact with the target surface, or to ensure that that the end or tip 1661 is in contact with the target surface with a specific force or pressure.

FIG. 13B shows an example embodiment of a flexible temperature probe 1610. In the illustrated embodiment, the flexible temperature probe 1610 includes at least one mount 120, at least one first flexible portion 1642, at least one second flexible portion 1644, and at least one sensing sub-assembly 1620 (analogous to the sensing sub-assemblies 114 or 1620) attached to the distal end of the second flexible portion 1644. In the illustrated embodiment, the flexible temperature probe 1610 is configured to be inserted into a channel 104 having an opening 108, at least one bend 106 and at least one target surface 1630 (analogous to the target surface 102 described herein with respect to FIG. 1). The probe 1610 is configured so that the sensing sub-assembly 1620 is placed in thermal communication with the target surface 1630. In various embodiments, the length of the portion of the probe 1610 within the channel 104 may be longer than the axial length of the channel 104 (X_{C}=X₁+X₂+X₃), to ensure contact of the sensing sub-assembly 1620 with the target surface 1630. In various embodiments, the length of the temperature probe 1610 within the channel 104 may be configured to result in the sensing sub-assembly 1620 being pushed into contact with the target surface 1630 with a force in the range of about 1 N to about 20 N or in the range of about 3 N to about 10 N, however the amount of the force could be any amount.

In various embodiments, it may be desirable to configure the flexible temperature probe 1610, for example to configure the spring force, the compression factor of a compliant member, or the length of the first flexible portion 1642, as well as other elements of the flexible temperature probe 1610, such that when inserted into the channel 104, a specific and repeatable force is applied between the tip of the sensing sub-assembly 1620 and the target surface 1630. For example, the flexible temperature probe 1610 may be configured to apply a target force that is repeatable to less than about ±5 N, or less than about ±2 N, or less than about ±1 N. In various embodiments, the flexible temperature probe 1610 may be configured to apply a force that is repeatable to less than about ±25% of the target force, or to less than about ±15% of the target force, or to less than about ±10% of the target force.

In various embodiments, the flexible temperature probe system 1610 may be configured to allow the temperature probe 1610 to be used in an environment having a pressure below or above one atmosphere, for example to prevent leakage of materials between an environment inside the flexible jacket and an environment outside or surrounding the flexible jacket. In various embodiments, the mount 120 may be configured to allow the temperature probe 1610 to be used in a vacuum or positive pressure environment.

In other embodiments, the mount 120 may be configured as a vacuum mount or feedthrough, for example, in embodiments where the environment in the measurement region is below atmospheric pressure (i.e., “under vacuum”). In various embodiments, such a vacuum mount may serve as an interface between the measurement region under vacuum and the surrounding environment. Various methods of manufacture of a vacuum mount or feedthrough, for example, using epoxy seals, O-ring seals, metal to glass seals or the like are known to those skilled in the art.

In still other embodiments, the mount 120 may be configured for operation at temperatures below or above ambient temperature. In such embodiments, the materials of construction of the mount 120 may be chosen to permit operation at temperatures of at least 100° C., at least 200° C., or greater than 300° C. In various embodiments, the materials of construction of the mount 120 may be chosen to permit operation at temperatures down to at least −50° C., at least down to −100° C., or below 150° C.

In any of the embodiments described herein, the materials of construction of the components of the flexible temperature probe in the measurement region, for example the flexible jacket, the sensing sub-assembly, the tip, and all associated sub-components, may be selected to support operation at relatively low temperatures, for example, below about −20° C. or below about −100° C., or to support operation at relatively high temperatures, for example, above about 200° C., above about 500° C., or above about 700° C. Example materials may include ceramics such as aluminum nitride, silicon carbide, zirconia, alumina and the like, polymers such as polytetrafluoroethylene (PTFE), polyvinyl chloride (PVC), polyethylene PAI, PI, PEI, PEEK, PTFE, PFA or the like, metals such as aluminum, stainless steel, titanium, nickel, gold, silver, alloys of metals or the like, or fibers such as silica or other materials. However, any of a wide variety of materials may be used in the components of the temperature probe.

In various embodiments, the flexible temperature probe may be constructed with no metal components in at least a portion of the flexible temperature probe. In various embodiments the flexible temperature probe may be constructed of non-ferrous materials. This may be advantageous, for example, in radio frequency field environments or electromagnetic field environments where such fields may couple to metal components and cause electrical interference, heating and/or other undesirable effects. Referring to the example embodiment shown in FIG. 13B, in various embodiments, the sensing sub-assembly 1620 may be constructed of non-metallic components. In various embodiments the sensing sub-assembly 1620, the first flexible portion 1642 and the mount 120 may be constructed of non-metallic components. In various embodiments, the sensing sub-assembly 1620, the first flexible portion 1642, the second flexible portion 1644 and the mount 120 may be constructed of non-metallic components.

In various embodiments, the sensing sub-assembly may be constructed of non-metallic materials, for example polymers, glasses or ceramics, as discussed herein. In various embodiments the sensing element may be constructed of non-metallic materials, for example, polymers, glasses or ceramics, as discussed herein. In various embodiments, the first flexible portion 1642 and/or second flexible portion 1644 may be constructed of polymers or non-metallic fibers, as discussed herein. In various embodiments, the flexible jackets described herein may be constructed of non-metallic materials, for example, polymers or non-metallic fibers, as discussed herein. In various embodiments, the connectors described herein may be constructed of non-metallic materials, for example polymers or ceramics.

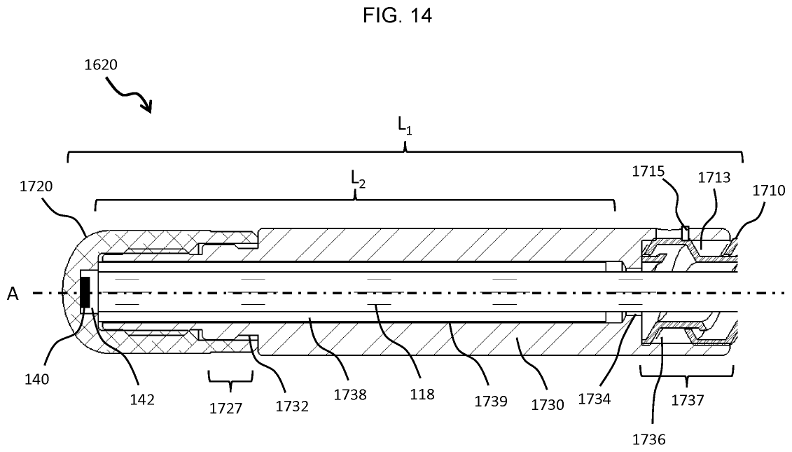

FIG. 14 shows a cross-section view of an example embodiment of the sensing sub-assembly 1620 shown in FIG. 13A. In the illustrated embodiment, the sensing sub-assembly 1620 includes a flexible jacket 1710, a tip 1720, an outer ferrule 1730, and an inner ferrule 1738. The outer ferrule 1730 has a first end and a second end disposed axially along an axis A, with at least a portion of the second end disposed inward relative to the tip 1720. The inner ferrule 1738 is disposed within at least a portion of the outer ferrule 1730. In the illustrated embodiment, the outer ferrule 1730 includes a passage 1734 sized to receive a plurality of fiber optic elements 118 therein. The plurality of fiber optic elements 118 has a proximal end and a distal end. The plurality of fiber optic elements 118 and the inner ferrule 1738 may be adhered to one another with an adhesive (e.g., glue, epoxy), fusing, or melt processing. The inner ferrule 1738 may be made of metal, glass, ceramics, polymer or any of a variety of materials.

In various embodiments, the outer ferrule 1730 may be secured to a portion of the plurality of fiber optic elements 118 and/or may be secured to the inner ferrule 1738 within or adjacent to the passage 1734 with an epoxy or other adhesive, for example, along all or portions of an interface 1739 between the outer ferrule 1730 and the inner ferrule 1738. The outer ferrule 1730 may be secured to the plurality of fiber optic elements 118 or the inner ferrule 1738 in a variety of manners. In various embodiments, the outer ferrule 1730 may be at least in part deformable, and as such the outer ferrule 1730 may be deformed or crimped in one or more locations to secure the flexible jacket 1710, the inner ferrule 1738, or the plurality of fiber optic elements 118. In various embodiments, an adhesive disposed along all or portions of the interface 1739 may be used to secure the outer ferrule 1730 to the inner ferrule 1738 and/or the plurality of optical fiber elements 118. The portion of the plurality of fiber optic elements 118 that is secured to the outer ferrule 1730 may be understood to be the distal portion of the plurality of fiber optic elements 118. In various embodiments, the outer ferrule 1730 may be made of metal, glass, ceramics, polymer, or the like or any combination thereof.

The tip 1720 and the outer ferrule 1730 may be securable to one another such that a sensing element 140 is in optical communication with the distal end of the plurality of fiber optic elements 118. In one embodiment, the tip 1720 may be threaded onto the outer ferrule 1730. In other embodiments, the tip 1720 may be secured to the outer ferrule 1730 at least in part with an overmold (e.g., a melt-processable or sintered fluoropolymer) or dip coat/potting compound. In still other embodiments, the tip 1720 and the outer ferrule 1730 may be secured to one another by adhesives, welding, or laser welding. In other embodiments, the tip 1720 may include one or more through-holes (not shown in FIG. 14) in positions that overlap with a portion of the outer ferrule 1730 which may be configured to allow passage of a one or more laser beams or a welding head, to facilitate welding of the tip 1720 to outer ferrule 1730.

In other embodiments, the tip 1720 and the outer ferrule 1730 may be secured to one another via crimping. For example, the tip 1720 may be crimped along a region identified as 1727, such that after such inward deformation, at least a part of the deformed portion of the tip 1720 at least in part interferes with axial movement of the outer ferrule 1730 relative to the tip 1720. As such, the tip 1720 and the outer ferrule 1730 may be crimped to one another. The outer ferrule 1730 may include a recess 1732 and the tip 1720 may be crimped at a location that overlaps the recess 1732, securing the tip 1720 to the outer ferrule 1730. The outer ferrule 1730 may be crimped in one location or more than one location. In other embodiments, a combination of more than one method of attachment may be utilized to attach the tip 1720 to the outer ferrule 1730, for example, the tip 1720 may be screwed onto the outer ferrule 1730 and then crimped. In other embodiments, a section of the plurality of fiber optic elements 118 may be partially or completely fused together or otherwise attached to each other to facilitate insertion into and/or attachment to the inner ferrule 1738 and/or the outer ferrule 1730. In various embodiments, a section of the plurality of fiber optic elements 118 having a region identified by L₁ or less, or having a region identified by L₂ or less may be fused or attached to each other to facilitate insertion into and/or attachment to the outer ferrule 1730 and/or inner ferrule 1738.

In the illustrated embodiment, the tip 1720 includes a sensing element 140. The sensing element 140 can be made from a thermographic phosphor material or a material containing a thermographic phosphor, or other material(s) suitable for temperature measurement. In the illustrated embodiment, the sensing element 140 is disposed within a cavity 142 formed in the tip 1720. In various embodiments, the sensing element 140 may be secured to the interior of the tip 1720, for example, by adhesive bonding, mechanical means, glass sealing or the like.

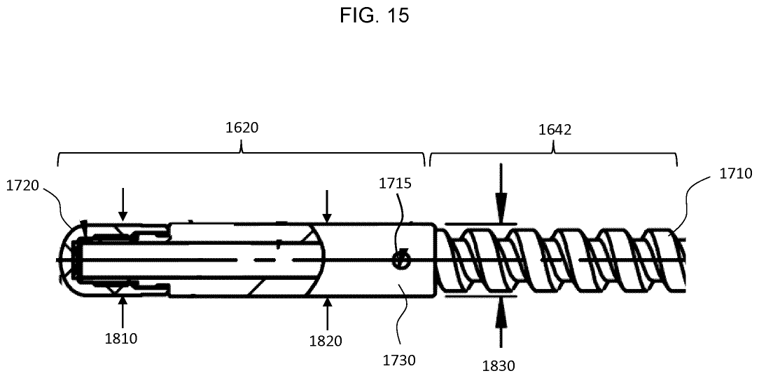

In one embodiment, the outer ferrule 1730 may include a passage 1736 sized to receive the flexible jacket 1710. The flexible jacket 1710 may be secured to the outer ferrule 1730 by a variety of means. In some embodiments, the flexible jacket 1710 may be secured to the outer ferrule 1730 at least in part with an overmold (e.g., a melt-processable or sintered fluoropolymer), dip coat/potting compound, or by adhesives. In other embodiments, the flexible jacket 1710 may be secured to the outer ferrule 1730 by crimping. For example, the outer ferrule 1730 may be crimped along a region identified as 1737, such that after inward deformation, the deformed part of outer ferrule 1730 at least in part interferes with axial movement of the outer ferrule 1730 relative to the flexible jacket 1710. In other embodiments, the outer ferrule 1730 may be crimped in one location or more than one location. In other embodiments, the outer ferrule 1730 may be optionally crimped at a location that overlaps a recess in the flexible jacket 1710, for example, a recess 1713, thereby securing the flexible jacket 1710 to the outer ferrule 1730. In other embodiments, a combination of more than one method of attachment may be utilized to secure the flexible jacket 1710 to the outer ferrule 1730, for example, the flexible jacket 1710 may be glued onto the outer ferrule 1730 and then crimped. The flexible jacket 1710 may be secured to the outer ferrule 1730 by welding or laser welding. The outer ferrule 1730 may include one or more through holes, for example, as identified as 1715 in FIGS. 14 and 15, which may be configured to allow passage of a one or more laser beams or a welding head, to facilitate welding of the outer ferrule 1730 to the flexible jacket 1710.

In various embodiments, the outer profile of the tip 1720, the outer ferrule 1730, and the flexible jacket 1710 may be configured or selected based on expected shapes or properties of the channel 104 and the bends 106 formed therein to facilitate insertion and removal of the sensing sub-assembly 1620 from the channel 104 and the bends 106 without jamming or binding.

FIG. 15 shows a view of an example embodiment of a sensing sub-assembly 1620 and a portion of a first flexible portion 1642, wherein the tip 1720, the outer ferrule 1730 and the flexible jacket 1710 have outer transverse dimensions or diameters of 1810, 1820 and 1830, respectively. In some embodiments, the transverse dimensions or the outer diameters 1810, 1820 and 1830 may be identical or substantially identical. In other embodiments, the values of the transverse dimensions or the outer diameters 1810, 1820 and 1830 may be configured to have a variation in size of less than about ±5%, or less than about ±10%, or less than about ±20%. In other embodiments, the transverse dimensions or the diameters 1810, 1820 and 1830 may be in the range of about 0.5 mm to about 10 mm, or in the range of about 1.5 mm to about 5 mm. Those skilled in the art will appreciate that the transverse dimensions or the outer diameters 1810, 1820 and 1830 may be configured in any way.

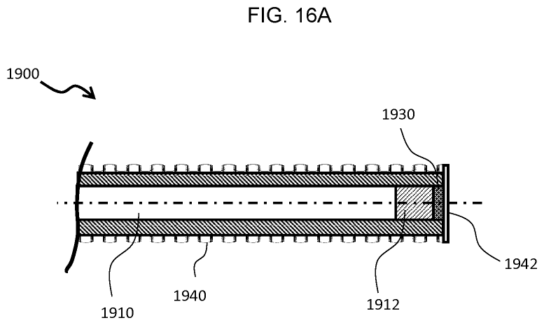

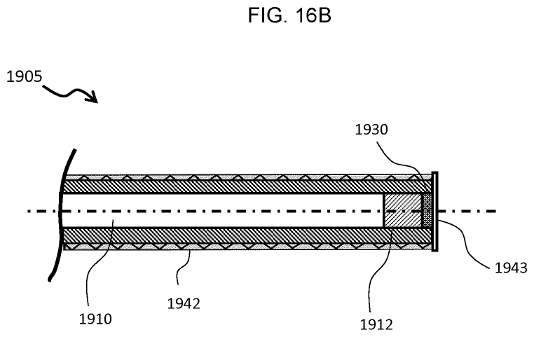

While various embodiments of the flexible temperature probes discussed with reference to FIGS. 3 to 15 include a rigid portion or tip, in other embodiments a cap may be used to enclose the distal end (the end where temperature is sensed) of the flexible jacket. FIGS. 16A and 16B show examples of two embodiments of a portion of a flexible temperature probe having a cap instead of a rigid portion or tip.

FIG. 16A shows a portion of an embodiment of a flexible temperature probe 1900 including a bellows-type flexible jacket 1940, a flexible bundle of fiber optic elements 1910 having a portion 1912 at or near the distal end that is optionally fused together and which is in optical communication with a sensing element 1930 (e.g., a thermographic phosphor) and a cap 1942, which may be attached to the distal end of flexible jacket 1940. The cap 1942 may be attached to the flexible jacket 1940 using a variety of means, for example with an adhesive (e.g., an epoxy), mechanically (e.g., crimping, laser welding), or the like.

FIG. 16B shows a portion of an embodiment of a flexible temperature probe 1905 including a braided or woven type flexible jacket 1942, a flexible bundle of fiber optic elements 1910 having a portion 1912 at or near the distal end that is optionally fused together and which is in optical communication with a sensing element 1930, and a cap 1943 which may be attached to the distal end of the flexible jacket 1942. In various embodiments, the cap 1943 may be attached to the flexible jacket 1942 using a variety of means, for example, adhesively (e.g., with an epoxy), mechanically (e.g., by crimping, or laser welding), or the like.

In some embodiments, the sensing element 1930 may be attached to the distal end of the flexible bundle of fiber optic elements 1910. The flexible bundle of fiber optic elements 1910 may have a portion at the distal end that is fused or otherwise joined together, for example, to aid in attachment of the sensing element 1930 to the distal end of flexible bundle of the fiber optic elements 1910. In other embodiments, the sensing element 1910 may be attached to the cap 1942 (FIG. 16A) or the cap 1943 (FIG. 16B). In some embodiments, the sensing element 1930 may be attached to the distal end of the flexible bundle of fiber optic elements 1910 using a variety of means, for example with an adhesive (e.g., an optically transparent (to wavelengths of light propagating in the flexible bundle of fiber optic elements 1910) adhesive or epoxy), diffusion bonding, glass sealing, mechanically, or the like or any combination thereof.

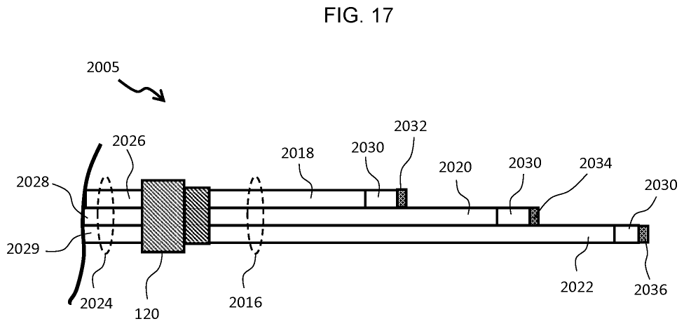

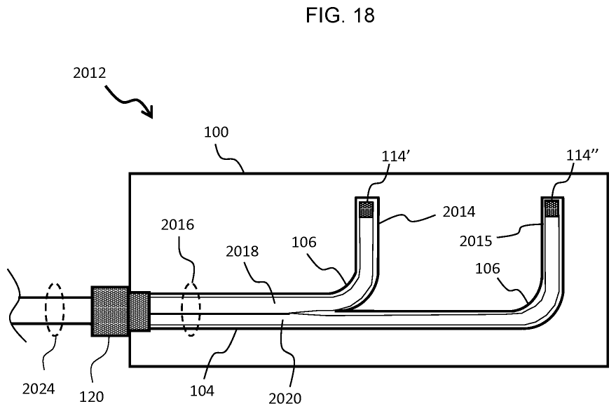

In various embodiments, a temperature probe may include more than one sensing point, sensing element, or sensing sub-assembly, as shown in FIGS. 17 and 18. FIG. 17 shows an example embodiment of a flexible temperature probe 2005 including a flexible bundle of fiber optic elements 2016 which may be divided optically and/or physically into three flexible portions 2018, 2020, and 2022 in optical communication with corresponding sensing elements 2032, 2034, and 2036 positioned at the distal ends of the flexible portions 2018, 2020, and 2022, respectively. The flexible temperature probe 2005 may include a proximal end 2024 and a mount 120 that may be configured to attach the flexible temperature probe 2005 to a body 100 (such as the body 100 shown in FIGS. 1 and 18). In some embodiments, the flexible temperature probe 2005 may be utilized to measure temperatures at different points along the length of a channel, for example, the channel 104 in FIG. 1 or 18. While FIG. 17 shows the flexible temperature probe 2005 split into three portions, in other embodiments the flexible temperature probe 2005 may be split into two portions or more than three portions.

In some embodiments, each of the flexible portions 2018, 2020, and 2022 may optionally include fused or attached portions 2030 which may be configured to facilitate attachment of the sensing elements 2032, 2034, and 2036 to corresponding flexible portions 2018, 2020, and 2022.

In some embodiments, the distal ends of the flexible portions 2018, 2020, and 2022 may be constrained, for example, as discussed above with respect to FIGS. 12A to 12C and FIGS. 16A and 16B. In various embodiments, the distal ends of the flexible portions 2018, 2020, and 2022 may be constrained to facilitate attachment of sensing elements 2032, 2034, and 2036. In various embodiments, the sensing elements 2032, 2034, and 2036 may be attached to the end of the flexible portions 2018, 2020, and 2022 by a variety of means, for example mechanical attachment, adhesives, sealing glass, or other methods. The method of attachment of the sensing elements 2032, 2034, and 2036 is not a limitation of the present disclosure. In various embodiments, the sensing elements 2032, 2034, and 2036 may be spaced apart from the end of respective flexible portions 2018, 2020, and 2022 in any way desired or beneficial.

While FIG. 17 shows the flexible portions 2018, 2020, and 2022 adjacent to each other, they may be constructed with different configurations. For example, in some embodiments, each of the flexible portions 2018, 2020, and 2022 may be attached to each other over all or a portion of the length of the other flexible portions 2018, 2020, and 2022, however, in other embodiments, all or a portion of each of the flexible portions 2018, 2020, and 2022 may be separated from each other.

In various embodiments, the proximal end 2024 of the flexible bundle of fiber optic elements 2016 may be physically and/or optically separated into portions (e.g., portions 2026, 2028, and 2029) corresponding optically to the portions 2018, 2020, and 2022 to permit separate measurement of the temperatures associated with the environments of the sensing elements 2032, 2034, and 2036.

In various embodiments, the multiple sensing points may be organized physically and/or optically as a part of a single bundle of flexible fiber optics. In other embodiments, one or more of the multiple sensing points may be completely separate from the other multiple sensing points.

While FIG. 17 shows the flexible temperature probe 2005 without a flexible jacket, in other embodiments, the flexible portions 2018, 2020 and 2022 (and their associated fused portions 2030 and sensing elements 2032, 2034 and 2036) may be completely or partially enclosed in a single flexible jacket. In other embodiments, each of the flexible portions 2018, 2020 and 2022 (and their associated fused portions 2030 and sensing elements 2032, 2034 and 2036) may be completely or partially enclosed in separate flexible jackets.

FIG. 18 shows an example embodiment of a flexible temperature probe 2012 including first flexible portion 2016 which may split into a second flexible portion 2018 and a third flexible portion 2020 and corresponding sensing sub-assemblies 114′ and 114″, which are positioned at the ends of the flexible portions 2018 and 2020, respectively. In the illustrated embodiment, the flexible temperature probe 2012 may include a mount 120 configured to attach the flexible temperature probe 2012 to a body 100. In various embodiments, the body 100 may include a channel 104 which may split into two portions 2014 and 2015, each having at least one bend 106. Portions of the flexible jackets 2018 and 2020 and sensing sub-assemblies 114′ and 114″ are positioned within the portions 2014 and 2015, respectively. While FIG. 18 shows the flexible temperature probe 2012 split into two portions, in other embodiments, the flexible temperature probe 2012 may be split into more than two portions.

In some embodiments, the distal ends of the flexible portions 2018 and 2020 may be constrained, for example, as discussed herein with respect to FIGS. 12A to 12C and FIGS. 16A and 16B. In some embodiments, the distal ends of the flexible portions 2018 and 2020 may be constrained to facilitate attachment of the sensing sub-assemblies 114′ and 114″. In other embodiments, the sensing sub-assemblies 114′ and 114″ may be attached to respective ends of the flexible portions 2018 and 2020 by a variety of means (e.g., mechanically, adhesively, by sealing glass, or the like or any combination thereof). The method of attachment of the sensing sub-assemblies 114′ and 114″ is not a limitation of the present disclosure. In various embodiments, the sensing elements 114′ and 114″ may be spaced apart from the end of the flexible portions 2018 and 2020.

In some embodiments, the proximal end 2024 of the flexible bundle of fiber optic elements 2016 may be physical and/or optically separated into portions corresponding optically to the flexible portions 2018 and 2020 to permit separate measurement of the temperatures associated with the environments of where the sensing sub-assemblies 114′ and 114″ are positioned. While FIG. 18 shows the flexible temperature probe 2012 without a flexible jacket, in other embodiments, the flexible portion 2016 may be enclosed in a flexible jacket and flexible portions 2018 and 2020 may or may not be enclosed in individual flexible jackets.

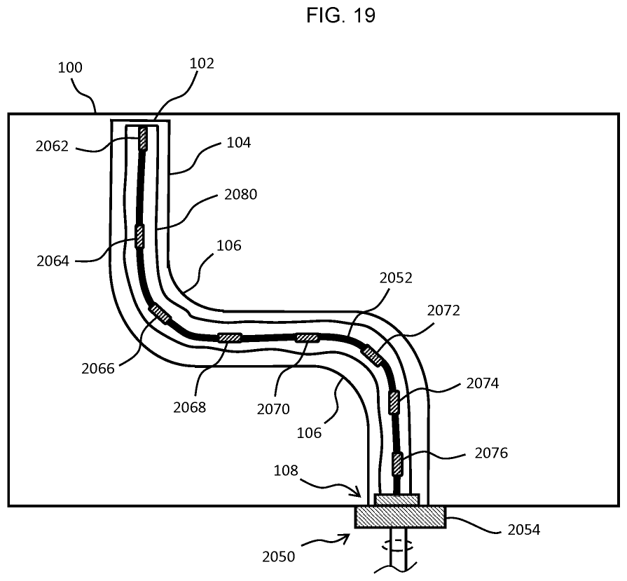

FIG. 19 shows a cross-section view of an example embodiment of fiber optic temperature probe (e.g., the multi-point sensing probe 2050) inserted into a channel 104 of a body 100. In the illustrated embodiment, the multi-point sensing probe 2050 has a plurality of sensing points 2062, 2064, 2066, 2068, 2070, 2072, 2074, and 2076. In the illustrated embodiment, the channel 104 includes at least one opening 108, one or more bends 106, and at least one target surface 102. Those skilled in the art will appreciate that the channel 104 may have any number of openings 108, bends 106, or target surfaces 102. In other embodiments, multiple channels 104 having any number of bends 106 may be formed in the body 100. In the illustrated embodiment, the multi-point sensing probe 2050 includes a mount 2054, a flexible jacket 2080, and one or more flexible fiber optic elements 2052 (also referred to herein as the “flexible probe body 2052”) in optical communication with the plurality of multiple sensing points 2062 to 2076. In various embodiments, the flexible fiber optic elements 2052 may be provided as an optical fiber bundle, a plurality of fiber optic elements (e.g., such as those described elsewhere herein), or a single fiber or other optical waveguide. The mount 2054 is configured to engage the opening 108 to retain the flexible fiber optic elements 2052 within the channel 104.

Each of the sensing points 2062 to 2076 are in thermal communication with the target surface 102 or the channel 104. In various embodiments, one or more of the multiple sensing points 2062 to 2076 may be a sensing sub-assembly (e.g., like the sensing sub-assemblies 114, 214, and 1620 described herein) or as a cap instead of a rigid tip portion, as described with respect to FIGS. 16A and 16B herein. In other embodiments, the sensing points 2062 to 2076 may be configured differently, for example, one or more of the multiple sensing points 2062 to 2076 may be provided as one or more Fiber Bragg Grating (FBG) sensing points (also referred to herein as “FBG sensors”) positioned along an optical fiber or the flexible fiber optic elements 2052.

In various embodiments, the multi-point sensing probe 2050 may configured to provide information about temperatures at different locations of the body 100, for example, at the target surface 102 as well as at points between the target surface 102 and the opening 108, such as the walls or interior surface of the channel 104. While in the illustrated embodiment the multi-point sensing probe 2050 has eight sensing points, in other embodiments, the number of sensing points may be less than or more than eight.

In various embodiments, one or more of the sensing points 2062 through 2076 may include a phosphor-based sensing elements, as described herein, though in other embodiments other sensing elements may be utilized, for example FBG sensors, pyrometric sensors, bandgap sensors, or the like or any combination thereof.

In various embodiments, all of the sensing points in the multi-point sensing probe 2050 may utilize the same sensing technology, however in other embodiments, the sensing points may utilize more than one sensing technology. For example, the multi-point sensing probe 2050 may include one or more sensing points having a first capability or attribute and one or more sensing points having a second capability or attribute. In various embodiments, different sensing capabilities or attributes may include accuracy, repeatability, reproducibility, cost, measurement resolution, spatial resolution, or the like or any combination thereof. For example, in some embodiments, the multi-point sensing probe 2050 may include one or more sensing points having high measurement accuracy and a larger number of sensing points having high spatial resolution. In such embodiments, a high accuracy sensing point may be used to calibrate a high spatial resolution sensing point located at the same or substantially the same location along the flexible probe body 2052. For example, the multi-point sensing probe 2050 may include one phosphor-based sensing point and multiple FBG sensing points, with one FBG sensing point co-located or located proximal to the phosphor-based sensing point. For example, the phosphor-based sensing point may provide high accuracy to calibrate the temperature measurement of the co-located FBG sensing point, while the remaining FBG sensing points may provide high spatial resolution of the temperature within the body 104 in which the multi-point sensing probe 2050 is positioned.

In various embodiments, different sensing capabilities may include temperature, strain, vibration, pressure, current, voltage or the like. Referring to FIG. 19, in various embodiments, movement of the flexible jacket 2080 may be partially or fully restricted within channel 104, for example, as described herein in reference to FIG. 13B in which the channel length X_{C} is configured to ensure contact of the sensing sub-assembly 1620 with the target surface 1630 of the channel 104. In such embodiments, the multi-point sensing probe 2050 is constrained to be unable to move or to substantially move relative to the channel 104, for example, in response to expansion and contraction from changes in the thermal environment. However, in other embodiments, movement of all portions of the multi-point sensing probe 2050 downstream of the mount 2054 (including, for example, the flexible jacket 2080 and any other portions, for example, a sensing sub-assembly) may be unrestricted within the channel 104. In such embodiments, the multi-point sensing probe 2050 can move lengthwise relative to the channel 104, for example, in response to expansion and contraction from changes in the thermal environment.

In various embodiments, the multi-point sensing probe 2050 may include one or more FBG sensors and all portions of the multi-point sensing probe 2050 downstream of the mount 2054 may be unconstrained to reduce or substantially reduce the sensitivity of the FBG sensors to strain, for example, in applications where temperature is to be measured by the FBG sensing points. In various embodiments, the multi-point sensing probe 2050 may include one or more FBG sensors and one or more portions of the multi-point sensing probe 2050 downstream of the mount 2054 may be constrained by all or portions of the channel 104 or the surface 102 or by other means, to increase or substantially increase the sensitivity of the FBG sensors to strain, for example, in applications where strain is to be measured by the FBG sensors. In various embodiments the multi-point sensing probe 2050 may include one or more FBG sensors and one or more portions of the multi-point sensing probe 2050 downstream of the mount 2054 may be unconstrained to reduce or substantially reduce the sensitivity to strain on the FBG sensors in the unconstrained region, for example in applications where temperature is to be measured by the FBG sensors in the unconstrained region and one or more portions of the multi-point sensing probe 2050 downstream of the mount 2054 may be constrained to increase or substantially increase the sensitivity of the FBG sensors to strain, for example in applications where strain is to be measured by the FBG sensors in the constrained region.

While FIG. 19 shows one multi-point sensing probe 2050 in the body 100, in other embodiments, though not shown, multiple multi-point sensing probes 2050 may be configured within the body 100. While FIG. 19 shows one multi-point sensing probe 2050 in the channel 104, in other embodiments, multiple multi-point sensing probes 2050 may be configured within the channel 104.

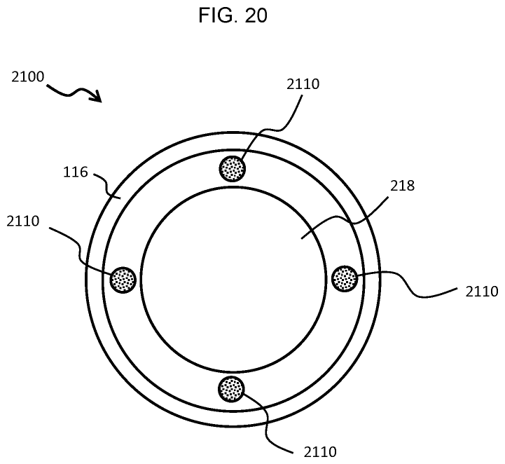

In various embodiments, the flexible temperature probes described herein may include control wires to enable remote articulation action, similar to that used in some borescopes. FIG. 20 shows a cross-section view of an example embodiment of a temperature probe 2100 having a flexible jacket 116, a bundle of flexible fiber optic elements 218 and a plurality of control wires 2110. While FIG. 20 shows four control wires 2110, in other embodiments the number of control wires 2110 may be less than four or greater than four. The length or tension of one or more of the control wires 2110 within the temperature probe 2100 may be adjusted to steer the temperature probe 2100 as required for specific applications. In other embodiments, one or more temperature sensing points may be incorporated into a borescope to allow for visual and thermal characterization.

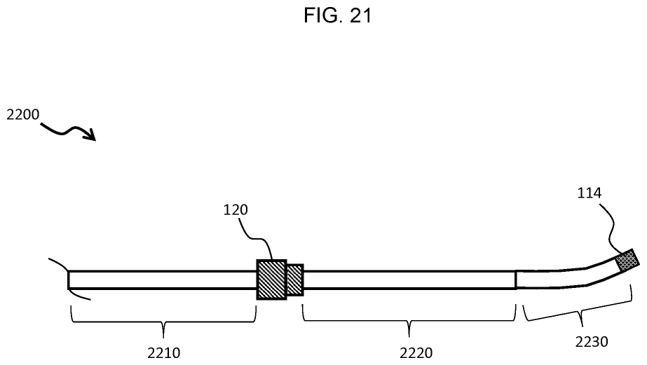

In various embodiments, the entire temperature probe downstream of a mount may be flexible, except for the sensing sub-assembly. However, in other embodiments, a portion of the temperature probe downstream of a mount may be rigid, followed by a flexible portion. FIG. 21 shows an example embodiment of a temperature probe 2200, including a portion 2210 upstream of a mount 120, a rigid portion 2220 downstream of the mount 120, and a flexible portion 2230 downstream of the rigid portion 2220, with a sensing sub-assembly. In various embodiments, the portion 2210 may include one or more rigid portions and/or one or more flexible portions. While FIG. 21 shows the flexible portion 2230 downstream of the rigid portion 2220, the temperature probe 2200 may include one or more rigid portions and one or more flexible portions arranged in any order.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A fiber optic temperature probe, comprising:
a plurality of flexible fiber optic elements having a first end and a second end;
a temperature sensing sub-assembly disposed on and in optical communication with the second end of the plurality of flexible fiber optic elements; and
a flexible jacket surrounding the plurality of fiber optic elements and secured to the temperature sensing sub-assembly, wherein the flexible jacket is operative to prevent relative movement between the flexible jacket and the temperature sensing sub-assembly,
wherein the flexible jacket comprises metal with at least one of a squarelock, interlock, monocoil, gooseneck, bellows or drag chain construction.

2. (canceled)

3. The fiber optic temperature probe of claim 1, wherein the flexible jacket comprises at least one of a polymer, a metal, at least one fiber or silica.

4. (canceled)

5. The fiber optic temperature probe of claim 3, wherein the flexible jacket includes a bend-limiting construction.

6. The fiber optic temperature probe of claim 3, wherein the flexible jacket has a minimum radius of curvature of 50 mm or less.

7. (canceled)

8. The fiber optic temperature probe of claim 1, wherein at least one portion of the plurality of flexible fiber optic elements comprises a fused flexible optical fiber bundle.

9. The fiber optic temperature probe of claim 3, wherein the flexible jacket comprises at least one of aluminum, steel, stainless steel, titanium, nickel, gold, silver or alloys thereof.

10. The fiber optic temperature probe of claim 1, further comprising a rigid tip wherein the rigid tip is configured to enclose all or at least a portion of the sensing sub-assembly and at least a portion of the second end of the plurality of flexible fiber optic elements.

11. The fiber optic temperature probe of claim 10, wherein the rigid tip comprises a metal rigid tip.

12. The fiber optic temperature probe of claim 2, further comprising:
a rigid tip, wherein:
(i) the rigid tip is configured to enclose all or at least a portion of the sensing sub-assembly and at least a portion of the second end of the plurality of flexible fiber optic elements and
(ii) the rigid tip is attached to at least a portion of the flexible jacket.

13. (canceled)

14. The fiber optic temperature probe of claim 1, further comprising:
a mount configured to engage an opening of a channel, the mount being a channel-length distance from the sensing sub-assembly, wherein the mount is secured the flexible jacket to prevent relative movement between the flexible jacket and the sensing sub-assembly.

15. The fiber optic temperature probe of claim 1, wherein the sensing sub-assembly is configured to pass through a minimum radius of a channel having one or more bends.

16. The fiber optic temperature probe of claim 1, wherein the sensing sub-assembly further comprises:
a ferrule having a first end and a second end;
a tip having a sensing element positioned therein, wherein the tip is secured to the second end of the ferrule.

17. The fiber optic temperature probe of claim 16, wherein the tip is detachably secured to the second end of the ferrule.

18. The fiber optic temperature probe of claim 2, wherein the flexible jacket is secured to the sensing sub-assembly by one or more of a friction fit, welding, crimping, an overmold, a dip coat, potting compound, and an adhesive connection.

19. The fiber optic temperature probe of claim 18, wherein the flexible jacket is disposed at least in part between an exterior portion and an interior portion of the sensing sub-assembly, and the flexible jacket is crimped to one or both of the exterior portion or the interior portion.

20. An assembly, comprising:
a body including a channel having at least one bend, the channel ending at a surface;
a temperature probe, comprising:
a plurality of fiber optic elements;
a sensing sub-assembly having a first and a second end, the first end connected to a distal portion of the plurality of fiber optic elements; and
a flexible jacket surrounding the plurality of fiber optic elements and secured to the sensing sub-assembly to prevent relative movement between the flexible jacket and the sensing sub-assembly, the temperature probe being positioned within the channel and passing through the at least one bend so the sensing sub-assembly is in thermal communication with the surface.

21. The assembly of claim 20, wherein the flexible jacket is formed from at least one of polytetrafluoroethylene, fiber, silica, or a metal.

22. A fiber optic temperature probe, comprising:
a bundle of fiber optic elements having a first end and a second end;
a collar having a first internal passage, the collar being secured to at least one of the first end and the second end of the bundle of fiber optic elements within the first internal passage; and
a sensing sub-assembly including a first part and a second part, the first part including:
a second internal passage for receiving the collar, wherein the first part of the sensing sub-assembly is secured to the collar within the second internal passage;
a flexible jacket surrounding the bundle of fiber optic elements; and
a projection formed on the collar, wherein the projection is configured to be secured to a portion of the flexible jacket, and wherein the second part includes a sensing element.

23. The fiber optic temperature probe of claim 22, wherein the first part and the second part of the sensing sub-assembly are removably attached.

24. The fiber optic temperature probe of claim 22, wherein the first part of the sensing sub-assembly is adhesively fixed to the collar.

25-28. (canceled)
